(19) United States
(12) Patent Application Publication
(10) Pub. No.: US 2006/0119724 A1
(43) Pub. Date: Jun. 8, 2006

(54) Imaging device, signal processing method on solid-state imaging element, digital camera and controlling method therefor and color image data generating method

(75) Inventor: Masafumi Inuiya, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/292,349

(22) Filed: Dec. 2, 2005

(30) Foreign Application Priority Data
Dec. 2, 2004 (JP) P.2004-349890
Dec. 2, 2004 (JP) P.2004-349891
Jan. 19, 2005 (JP) P.2005-011842

(51) Int. Cl. H04N 5/335

(52) U.S. Cl. 348/311

(57) ABSTRACT

An imaging device for imaging an object to generate a color image data, comprising: a solid-state imaging element comprising: a photoelectric conversion layer laminated above a semiconductor substrate; photoelectric conversion elements comprising at least two kinds of photoelectric conversion elements aligned on the semiconductor substrate for detecting colors different from that to be detected by the photoelectric conversion layer; and a signal reading circuit formed on the semiconductor substrate for reading out color signals according to signal charge accumulated in the photoelectric conversion elements and signal charge generated in the photoelectric conversion layer; and a color signal generating unit for generating a color signal constituting one-pixel data in the color image data on the basis of signal charge accumulated in a first photoelectric conversion element corresponding the one-pixel data among the photoelectric conversion elements and signal charge accumulated in at least one second photoelectric conversion element, adjacent to the first photoelectric conversion element, for detecting the same color as that of the first photoelectric conversion element.

### BACKGROUND OF THE INVENTION

1. Field of the Invention

The present invention relates to an imaging device which takes a picture of an object to generate a color image data.

The present invention relates to a color image data generating method which generates a color image data from at least three color signals obtained by imaging an object.

The present invention relates to an imaging device having a solid-state imaging element which comprises a plurality of photoelectric conversion layers each having a plurality of pixels and reads a signal charge out of the pixels in the photoelectric conversion layers as a pixel signal, a signal processing method on solid-state imaging element, a digital camera and a controlling method therefor.

2. Description of the Related Art

As a solid-state imaging element free of color filter there has heretofore been proposed, e.g., laminated solid-state imaging element disclosed in JP-A-2002-83946. This laminated solid-state imaging element comprises photoelectric conversion layers made of three organic materials for detecting red (R), green (G) and blue (B) lights, respectively, laminated above a semiconductor substrate. Signal charges generated in the various layers are accumulated in storage diodes formed on the semiconductor substrate. The signal charges accumulated in the storage diodes are read out by a signal reading circuit such as vertical CCD and horizontal CCD formed on the semiconductor substrate, and then transmitted. In accordance with the laminated solid-state imaging element, the percent light utilization can be raised to inhibit the generation of false colors, making it possible to generate a high quality color image.

The aforementioned laminated solid-state imaging element requires a contact wiring connecting between one of two electrode layers having the various photoelectric conversion layers laminated above the semiconductor substrate interposed therebetween and the storage diodes formed on the semiconductor substrate. The material constituting the contact wiring is a metal such as tungsten, copper and molybdenum. In order to form the wiring configuration, a temperature as high as 300° C. or more is needed. On the other hand, the photoelectric conversion layer laminated above the semiconductor substrate is made of an organic material and apparently undergoes deterioration of properties when exposed to a temperature as high as 200° C. or more. The production of the aforementioned laminated solid-state imaging element involves the repetition of step of producing a photoelectric conversion layer after the formation of a contact wiring. It is thus disadvantageous in that the properties of the photoelectric conversion layer formed earlier are deteriorated by the heat used during the formation of contact wiring.

As a solid-state imaging element capable of solving these problems there has been proposed a hybrid type solid-state imaging element comprising photoelectric conversion elements made of silicon for detecting R and B integrated on a semiconductor substrate and one photoelectric conversion layer made of an organic material for detecting G above the semiconductor substrate (see, e.g., JP-A-2003-332551 (paragraph 0035)). This hybrid type solid-state imaging element shows no deterioration of properties of silicon even at a temperature as high as 300° C. or more. Accordingly, the hybrid type solid-state imaging element can be produced by forming photoelectric conversion layers at a low temperature process after the formation of a lower portion (photoelectric conversion element or contact wiring) at a high temperature process. Thus, the deterioration of properties of photoelectric conversion layers can be prevented.

In the aforementioned hybrid type solid-state imaging element, the percent opening of the photoelectric conversion layers in the upper portion is approximately 100% while the percent opening of the photoelectric conversion elements in the lower portion is lower than that of the photoelectric conversion layers in the upper portion. Further, the effect of contact wiring connected to the photoelectric conversion layers in the upper portion, etc. causes the amount of light rays that can be incident on the photoelectric conversion elements in the lower portion to be less than that of the photoelectric conversion layers in the upper portion. It is thus disadvantageous in that the amount of signal charges generated in the photoelectric conversion layers in the upper portion per constant amount of incident light rays is greater than the amount of signal charges generated in the photoelectric conversion elements in the lower portion per constant amount of incident light rays, causing the dispersion of sensitivity or the deterioration of S/N ratio of signals obtained from the photoelectric conversion elements in the lower portion (Problem 1).

In addition, in the aforementioned hybrid type solid-state imaging element, three color R, G and B signals constituting one-pixel data in color image data cannot be obtained from the same position. It is thus necessary that R and B color signals be subjected to signal interpolation with color signals originally obtained during the generation of a color image data. Therefore, there occurs a problem that false colors become remarkable (Problem 2).

A prototype example of multi-layer solid-state imaging element is one disclosed in JP-A-58-103165. This solid-state imaging element comprises three light-sensitive layers laminated on a semiconductor substrate. In this arrangement, Red (R), green (G) and blue (B) electrical signals detected in the respective light-sensitive layer are read out by MOs circuit formed on the semiconductor substrate.

The solid-state imaging element having the aforementioned configuration was proposed in the past. Since then, CCD type image sensors or CMOS type image sensors comprising a numeral light-receiving portions (photodiode) integrated on the surface of a semiconductor substrate and various color filters of red (R), green (G) and blue (B) have shown a remarkable progress. The present technical trend is such that an image sensor having millions of light-receiving portions (pixels) integrated on one chip is incorporated in digital still cameras.

However, the technical progress of CCD type image sensors and CMOS type images has been almost limited. The size of the opening of one light-receiving portion is about 2 μm, which is close to the order of wavelength of incident light. Therefore, they types of image sensors face a problem of poor yield in production.

Further, the upper limit of the amount of photocharge that can be accumulated in one fine light-receiving portion is as low as about 3,000 electrons, with which 256 gradations can be difficultly expressed completely. Therefore, it has been difficult to expect CCD type or CMOS type image sensor capable of outputting a higher quality from the standpoint of image quality or sensitivity.

As a solid-state imaging element that gives solution to these problems, a solid-state imaging element proposed in JP-A-58-103165 has attracted attention. An image sensor disclosed in JP-A-2003-332551 has been newly proposed.

In accordance with the solid-state imaging element comprising a multi-layer photoelectric conversion portion as disclosed in JP-A-58-103165 and JP-A-2003-332551, however, signal charges generated in RGB photoelectric conversion portions are introduced into a lower signal charge transmitting portion. Therefore, Via contact connecting between a transparent pixel electrode and a lower charge accumulating diode is needed. This Via contact is made of a metal such as tungsten, copper and molybdenum, which is opaque to visible light. Therefore, even when the percent opening of the uppermost layer photoelectric conversion portion among the three-layer photoelectric conversion portions is 100%, the opening of the lower photoelectric conversion portions is smaller by light shielding by Via contact. In particular, as the pixel is more finely divided, the percent opening lowers with the downward position of the layers. When the light absorption of the upper layer is great, the amount of light that reaches the lower layers decreases, resulting in the occurrence of a phenomenon that the upper layers have a high sensitivity while the lower layers have a low sensitivity. Further, when the sensitivity of the uppermost layer is raised by increasing the light absorption of the uppermost layer and the half-width of spectral sensitivity, the amount of light that reaches the lower layers is remarkably reduced. When the sensitivity is lowered, limitation on picture-taking conditions must be severer to secure the received amount of light. Further, the S/N ratio of signal is lowered, deteriorating image quality. Accordingly, in order to enhance image quality, it is separately necessary that the sensitivity of the lower layers be raised, unavoidably causing cost rise.

There is a trade-off relationship between color resolution of picture image and S/N ratio of pixel signal. As a result, S/N ratio of pixel signals are uniformly predetermined according to the number of pixels (light-receiving area) in the solid-state imaging element. Accordingly, it cannot be freely selected which should be considered important color resolution or S/N ratio according to the picture-taking purpose or the object to be picture-taken, making it impossible to optimize the picture-taking conditions flexibly for the scene to be picture-taken.

Solid-state imaging elements include a multi-plate type imaging element comprising various hue (R, G, B, etc.) photoelectric conversion portions disposed at different positions, whereby light in a specific wavelength range is deflected by a prism or the like and then detected. In this type of a solid-state imaging element, it is difficult to uniform the sensitivity characteristics of the various hue photoelectric conversion layers. Therefore, the sensitivity adjustment cannot be made unless the materials to be used or the layer formation conditions are changed. Accordingly, when a photoelectric conversion layer for a specific hue can be made of a high sensitivity material, but other hue photoelectric conversion layers must be made of a relatively low sensitivity material, the performance of the element is predetermined on the basis of the low sensitivity material, making it impossible for the element to sufficiently exhibit the properties of the high sensitivity material. The aforementioned problems are referred to as problem 3.

### SUMMARY OF THE INVENTION

The invention has been worked out under these circumstances (Problem 1). An aim of the invention is to allow an imaging device comprising a hybrid type solid-state imaging element having a photoelectric conversion layer provided as an upper portion and a photoelectric conversion element made of silicon provided as a lower portion to generate a high quality color image data.

The imaging device of the invention concerns an imaging device for taking a picture of an object to generate a color image data, comprising:

a solid-state imaging element having an photoelectric conversion layer laminated above a semiconductor substrate, a plurality of photoelectric conversion elements containing at least two kinds of photoelectric conversion elements aligned on the semiconductor substrate for detecting colors different from that to be detected by the photoelectric conversion layer and a signal reading circuit formed on the semiconductor substrate for reading out color signals according to signal charge accumulated in the plurality of photoelectric conversion elements and signal charge generated in the photoelectric conversion layer; and a color signal generating unit for generating a color signal constituting one-pixel data in the color image data on the basis of signal charge accumulated in a photoelectric conversion element corresponding the one-pixel data among the plurality of photoelectric conversion elements and signal charge accumulated in another photoelectric conversion element aligned adjacent to the photoelectric conversion element for detecting the same color as that of the photoelectric conversion element.

In this arrangement, the sensitivity or S/N ratio of the color signal thus generated can be enhanced, making it possible to generate a high quality color image data.

In the imaging device of the invention, the color signal generating unit adds a color signal corresponding to signal charge accumulated in the photoelectric conversion element corresponding to one-pixel data in the color image data and a color signal corresponding to signal charge accumulated in the photoelectric conversion element adjacent to the former photoelectric conversion element for detecting the same color as that of the former photoelectric conversion element at a predetermined ratio to generate a color signal constituting the one-pixel data.

In this arrangement, analog or digital color signal can be subjected to signal processing, making it possible to enhance the sensitivity or S/N ratio of a color signal constituting a color image data.

In the imaging device of the invention, the signal reading circuit comprises vertical transmission channels through which signal charge accumulated in the plurality of photoelectric conversion elements and signal charge generated in the photoelectric conversion layer are each transmitted in specific directions on the semiconductor substrate, a horizontal transmission channel through which signal charges transmitted through the vertical transmission channels are each transmitted in the direction perpendicular to the specific directions and an outputting portion for outputting a color signal corresponding to signal charge transmitted through the horizontal transmission channel and the color signal generating unit generates a color signal constituting the one-pixel data by driving the solid-state imaging element such that signal charge accumulated in the photoelectric conversion element corresponding to one-pixel data in the color image data and signal charge accumulated in the photoelectric conversion element adjacent to the former photoelectric conversion element for detecting the same color as that of the former photoelectric conversion element are mixed in the vertical transmission channels and the horizontal transmission channel.

In this arrangement, signal charges accumulated in the photoelectric conversion elements are mixed, making it possible to enhance the sensitivity or S/N ratio of a color signal constituting color image data.

In the imaging device of the invention, the solid-state imaging element has a signal charge accumulating portion provided on the semiconductor substrate for accumulating signal charge generated in the photoelectric conversion layer and the semiconductor substrate has lines having the at least two kinds of photoelectric conversion elements aligned alternately thereon and lines having the signal charge accumulating portions aligned thereon, the two lines being aligned apart from each other in the line direction at a dimension of substantially half the line alignment pitch of the photoelectric conversion elements and the signal charge accumulating portions.

In this arrangement, a zigzag vertical transmission channel can be employed as a signal reading circuit, making it possible to raise the transmission capacity of signal charge. Accordingly, the area of the photoelectric conversion layer or the photoelectric conversion element can be raised, making it possible to generate a color image data having a higher quality.

In the imaging device of the invention, the solid-state imaging element has a signal charge accumulating portion provided on the semiconductor substrate for accumulating signal charge generated in the photoelectric conversion layer and the plurality of photoelectric conversion elements and the signal charge accumulating portion are aligned in the form of square lattice and each are aligned checkerwise.

In this arrangement, a high resolution color image data can be generated.

In the imaging device of the invention, the signal reading circuit comprises an MOS transistor and a signal line connected to the MOS transistor and the plurality of photoelectric conversion elements comprise the at least two kinds of photoelectric conversion elements laminated in the depth direction of the semiconductor substrate which are aligned on the same plane in the semiconductor substrate.

In the imaging device of the invention, the solid-state imaging element comprises a plurality of microlens provided above the photoelectric conversion layer for converging light rays onto the plurality of photoelectric conversion elements.

In the imaging device of the invention, the solid-state imaging element comprises a plurality of microlens provided interposed between the photoelectric conversion layer and the plurality of photoelectric conversion elements for converging light rays onto the plurality of photoelectric conversion elements.

In the imaging device of the invention, the photoelectric conversion layer detects green light and the at least two kinds of photoelectric conversion elements comprise photoelectric conversion elements for detecting red light and photoelectric conversion elements for detecting blue light.

In the imaging device of the invention, the photoelectric conversion layer comprises an organic material.

The digital camera of the invention performs imaging by using a imaging device as described above.

The color image data generating method of the invention concerns a color image data generating method for taking a picture of an object to generate a color image data, comprising a color signal generating step of generating, on the basis of signal charge accumulated in a solid-state imaging element comprising a photoelectric conversion layer laminated on a semiconductor substrate, a plurality of photoelectric conversion elements containing at least two photoelectric conversion elements aligned on the semiconductor substrate for detecting colors different from that to be detected by the photoelectric conversion layer and a signal reading circuit formed on the semiconductor substrate for reading out color signals according to signal charge accumulated in the plurality of photoelectric conversion elements and signal charge generated in the photoelectric conversion layer at the photoelectric conversion element corresponding to one-pixel data in the color image data among the plurality of photoelectric conversion elements and signal accumulated in another photoelectric conversion element aligned adjacent to the photoelectric conversion element for detecting the same color as that of the photoelectric conversion element, a color signal constituting the one-pixel data.

In the color image data generating method of the invention, the color signal generating step adds a color signal corresponding to signal charge accumulated in the photoelectric conversion element corresponding to one-pixel data in the color image data and a color signal corresponding to signal charge accumulated in the photoelectric conversion element adjacent to the former photoelectric conversion element for detecting the same color as that of the former photoelectric conversion element at a predetermined ratio to generate a color signal constituting the one-pixel data.

In the color image data generating method of the invention, the signal reading circuit comprises vertical transmission channels through which signal charge accumulated in the plurality of photoelectric conversion elements and signal charge generated in the photoelectric conversion layer are each transmitted in specific directions on the semiconductor substrate, a horizontal transmission channel through which signal charges transmitted through the vertical transmission channels are each transmitted in the direction perpendicular to the specific directions and an outputting portion for outputting color signal corresponding to signal charge transmitted through the horizontal transmission channel and the color signal generating step generates a color signal constituting the one-pixel data by driving the solid-state imaging element such that signal charge accumulated in the photoelectric conversion element corresponding to one-pixel data in the color image data and signal charge accumulated in the photoelectric conversion element adjacent to the former photoelectric conversion element for detecting the same color as that of the former photoelectric conversion element are mixed in the vertical transmission channels and the horizontal transmission channel.

In accordance with the invention, a hybrid type solid-state imaging element comprising a photoelectric conversion layer provided as an upper portion and a photoelectric conversion element made of silicon provided as a lower portion can generate a high quality color image data.

The invention has been worked out under these circumstances (problem 2). An aim of the invention is to provide a color image data generating method capable of generating a color image data having little false colors.

The color image data generating method of the invention concerns a color image generating method for generating a color image data from at least three color signals obtained by imaging an object, wherein the three color signals comprise a first color signal in a number corresponding to the total pixel data in the color image data, a second color signal in a number corresponding to a part of the total pixel data in the color image data and a third color signal in a number corresponding to the other part of the total pixel data in the color image data and there are comprised a color signal providing step of obtaining the first color signal, the second color signal and the third color signal, a fourth color signal generating step of subtracting the first color signal from the second color signal on the same sample points as that of the color signals thus obtained, a fifth color signal generating step of subtracting the first color signal from the third color signal on the same sample points as that of the color signals thus obtained and a color signal generating step of generating a color signal constituting one-pixel data in the color image data on the basis of the fourth and fifth color signals.

In accordance with the color image data generating method of the invention, the color signal generating step comprises a first interpolating step of interpolating in points having the fifth color signals present thereon but free of the fourth color signals the fourth color signals present in the surroundings of the points, a second interpolating step of interpolating in points having the fourth color signals present thereon but free of the fifth color signals the fifth color signals present in the surroundings of the points, a sixth color signal generating step of adding the fourth color signals interpolated in the sample points which have originally had no fourth color signals present thereon and the fourth color signals present in the surroundings of the sample points at a predetermined ratio to generate a sixth color signal on the sample points, a seventh color signal generating step of adding the fifth color signals interpolated in the sample points which have originally had no fifth color signals present thereon and the fifth color signals present in the surroundings of the sample points at a predetermined ratio to generate a seventh color signal on the sample points and an adding step of adding the sixth color signal or the seventh color signal and the first color signal present on the same sample points as the color signal, by which adding step a color signal constituting the one-pixel data is generated.

In accordance with the color image data generating method of the invention, the color signal generating step comprises a first interpolating step of interpolating in points having the fifth color signals present thereon but free of the fourth color signals the fourth color signals present in the surroundings of the points, a second interpolating step of interpolating in points having the fourth color signals present thereon but free of the fifth color signals the fifth color signals present in the surroundings of the points, a sixth color signal generating step of adding the fourth color signals present on the various sample points and the fourth color signals present in the surroundings of the sample points at a predetermined ratio to generate a sixth color signal on the sample points, a seventh color signal generating step of adding the fifth color signals present on the various sample points and the fifth color signals present in the surroundings of the sample points at a predetermined ratio to generate a seventh color signal on the sample points and an adding step of adding the sixth color signal present and the first color signal present on the same sample points as the color signal and adding the seventh color signal and the first color signal present on the same sample points as the color signal, by which adding step a color signal constituting the one-pixel data is generated.

In accordance with the color image data generating method of the invention, there are comprised a step of adding the second color signal and the color signal of the same kind present on the sample points in the surroundings of the sample point having the second color signal present thereon at a predetermined ratio to generate new second color signals on the sample points and a step of adding the third color signal and the color signal of the same kind present on the sample points in the surroundings of the sample point having the third color signal present thereon at a predetermined ratio to generate new third color signals on the sample points, the fourth color signal generating step uses the new second color signal instead of the second color signal to generate the fourth color signal and the fifth color signal generating step uses the new third color signal instead of the third color signal to generate the fifth color signal.

In accordance with the color image data generating method of the invention, the first to third color signals are obtained from a solid-state imaging element comprising one photoelectric conversion layer laminated above a semiconductor substrate, a signal charge accumulating portion formed on the surface of the semiconductor substrate for accumulating a signal charge generated in the photoelectric conversion layer and two kinds of photoelectric conversion elements formed on the surface of the semiconductor substrate for detecting different colors, respectively, the signal charge accumulating portion is formed in a number corresponding to the total pixel data in the color image data, the two photoelectric conversion elements are, in sum total, formed in a number corresponding to the total pixel data in the color image data, the first color signal is a signal corresponding to the signal charge accumulated in the signal charge accumulating portion, the second color signal is a signal corresponding to the signal charge generated in one of the two photoelectric conversion elements, and the third color signal is a signal corresponding to the signal charge generated in the other of the two photoelectric conversion elements.

In accordance with the invention, there can be provided a color image data generating method capable of generating a color image data having little false colors.

In addition, the invention has been worked out in the light of the problem 3. A first aim of the invention is to provide an imaging device which can enhance S/N ratio of pixel signal while inhibiting the deterioration of visual color resolution even when the brightness of the object to be picture-taken is low, making it possible to enhance the sensitivity balance of photoelectric conversion portions of various hues and hence image quality and sensitivity and a signal processing method on solid-state imaging element. A second aim of the invention is to provide an imaging device capable of freely selecting which should be considered important color resolution or S/N ratio according to picture-taking conditions, etc., a signal processing method on solid-state imaging element, a digital camera and a controlling method therefor.

The aforementioned aims of the invention are accomplished with the following constitutions.

(1) An imaging device having a solid-state imaging element which comprises a plurality of photoelectric conversion layers each having a plurality of pixels and reads a signal charge out of the pixels in the photoelectric conversion layers as a pixel signal, comprising:

a first photoelectric conversion layer for absorbing light rays in the green wavelength range to generate a signal charge;

at least a second photoelectric conversion layer for absorbing mainly light rays in a wavelength range different from the green wavelength range to generate a signal charge; and

a pixel signal generating unit for generating a pixel signal according to the signal charge from the first photoelectric conversion layer and the second photoelectric conversion layer, wherein the pixel signal generating unit generates on one pixel in the first photoelectric conversion layer a pixel signal for the position of the one pixel on the basis of a value according to processing of various signal charges in the corresponding pixel in the second photoelectric conversion layer at the position corresponding to the one pixel and in surrounding pixels adjacent to the corresponding pixel and a value according to signal charge in the one pixel in the first photoelectric conversion layer.

In accordance with the aforementioned imaging device, a pixel signal is generated with the resolution of various pixels in the first photoelectric conversion layer left unchanged and a pixel signal is generated by processing a plurality of pixels corresponding to the second photoelectric conversion layer having little effect on visual resolution, making it possible to enhance S/N ratio of pixel signal while inhibiting the deterioration of visual color resolution even when the brightness of the object to be picture-taken is low. In this arrangement, the sensitivity balance of photoelectric conversion portions of various hues can be enhanced to enhance image quality and sensitivity.

(2) The imaging device as defined in Clause (1), wherein the first light-receiving layer and the at least one second light-receiving layer are laminated on each other and the first light-receiving layer is disposed on the light incidence side to transmit light rays in wavelength ranges other than the green wavelength range.

In accordance with the aforementioned imaging device, even when the photoelectric conversion portion is a laminated solid-state imaging element, there occurs no deterioration of image quality due to the reduction of the amount of light that reaches the underlying photoelectric conversion layers.

(3) An imaging device having a multi-layer solid-state imaging element which comprises a plurality of photoelectric conversion layers each having a plurality of pixels and reads a signal charge out of the pixels in the photoelectric conversion layers, comprising:

a G photoelectric conversion layer disposed in the uppermost layer on the light incidence side which absorbs G (green) light to generate a G signal charge according to the amount of the G light and transmits R (red) light and B (blue) light;

a B photoelectric conversion layer which absorbs B light to generate a B signal charge according to the amount of the B light and transmits R light;

an R photoelectric conversion layer which absorbs R light to generate an R signal charge according to the amount of the R light; and

a signal processing portion which reads a signal charge out of the pixels in the G photoelectric conversion layer, the B photoelectric conversion layer and the R photoelectric conversion layer to generate a pixel signal, wherein the signal processing portion generates on one pixel in the G photoelectric conversion layer a pixel signal for the position of the one pixel on the basis of a value according to processing of various signal charges in the corresponding pixel in other photoelectric conversion layers at the position corresponding to the one pixel and in the surrounding pixels adjacent to the corresponding pixel and a value according to signal charge in the one pixel in the G photoelectric conversion layer.

In accordance with the aforementioned imaging device, a pixel signal is generated with the resolution of various pixels in the G photoelectric conversion layer left unchanged and a pixel signal is generated by processing a plurality of pixels corresponding to other photoelectric conversion layers, making it possible to enhance the sensitivity balance of photoelectric conversion layers of various hues and hence the image quality and sensitivity. Although the photoelectric conversion portion is a laminated solid-state imaging element, there occurs no deterioration of image quality due to the reduction of the amount of light that reaches the underlying photoelectric conversion portions.

(4) The imaging device as defined in Clause (3), wherein the other photoelectric conversion layers include a B photoelectric conversion layer.

In accordance with the aforementioned imaging device, a pixel signal is generated by processing a plurality of B photoelectric conversion layers having little effect on visual resolution, making it possible to enhance S/N ratio of pixel signal while inhibiting the deterioration of visual color resolution.

(5) The imaging device as defined in Clause (3) or (4), wherein the other photoelectric conversion layers include an R photoelectric conversion layer.

In accordance with the aforementioned imaging device, a pixel signal is generated by processing a plurality of R photoelectric conversion layers having little effect on visual resolution, making it possible to enhance S/N ratio of pixel signal while inhibiting the deterioration of visual color resolution.

(6) The imaging device as defined in any one of Clauses (1) to (4), wherein the processing of signal charge involves mixing charges accumulated in the various pixels in the photoelectric conversion layers.

In accordance with the aforementioned imaging device, the mixing of charges makes it possible to enhance the substantial sensitivity as well as S/N ratio of signal. The aforementioned imaging device also allows high speed processing.

(7) The imaging device as defined in any one of Clauses (1) to (4), wherein the processing of signal charge involves addition of pixel signals generated on the basis of signal charges in the various pixels in the photoelectric conversion layers.

In accordance with the aforementioned imaging device, the addition of pixels makes it possible to enhance the substantial sensitivity as well as S/N ratio of signal. Further, the pixels to be added can be easily and arbitrarily selected, making it easy to adjust the effect of pixel addition.

(8) The imaging device as defined in Clause (7), comprising an analog circuit for adding the pixel signals by analog signal processing.

In accordance with the aforementioned imaging device, a simple circuit can be used to perform addition at a high speed.

(9) The imaging device as defined in Clause (7) or (8), comprising a low pass filter for passing the pixel signals.

In accordance with the aforementioned imaging device, pixel signals pass through a low pass filter, making it easy to exert the effect corresponding to addition.

(10) The imaging device as defined in Clause (7), comprising a digital circuit for adding the pixel signals by digital signal processing.

In accordance with the aforementioned imaging device, addition can be finely predetermined, making it possible to enhance the degree of freedom of adjustment of effect of addition.

(11) The imaging device as defined in any one of Clauses (6) to (10), comprising a weighting unit for effecting weighting according to the relative pixel position corresponding to the pixel to be processed in the signal charge processing.

In accordance with the aforementioned imaging device, weighting can be effected according to the position of pixel relative to the pixel to be processed to give an independent degree of weighting according to the position of pixel. Accordingly, it can be arbitrarily predetermined whether or not pixel signals from pixels other than the pixel to be processed should be added or, if so, what degree they should be added.

(12) The imaging device as defined in Clause (11), comprising a photometric unit for detecting the brightness of an object and a weighting coefficient predetermining unit for predetermining the weighting coefficient according to the results of brightness detected by the photometric unit.

In accordance with the aforementioned imaging device, the weighting coefficient can be predetermined according to the brightness of the object, making it possible to perform optimum picture-taking according to the brightness of the image to be picture-taken. In other words, when the object to be picture-taken is bright, the color resolution is considered important and no substantial addition of various pixels is effected because the resolution of image often forms a factor governing the superiority or inferiority of the image quality. On the other hand, when the object to be picture-taken is dark, substantial addition of various pixels other than G pixels is effected to enhance sensitivity and hence S/N ratio because the rise of noise ratio causes S/N ratio of image to govern the superiority or inferiority of the image quality. In this manner, even when the brightness of the object to be picture-taken is low, a pixel signal having a high S/N ratio can be obtained while inhibiting the deterioration of color resolution.

(13) The imaging device as defined in Clause (11), comprising a picture-taking mode predetermining unit for predetermining either high sensitivity mode or ordinary mode and a weighting coefficient predetermining unit for predetermining the weighting coefficient according to the picture-taking mode predetermined by the picture-taking mode predetermining unit.

In accordance with the aforementioned imaging device, during high sensitivity picture-taking of a low brightness object to be picture-taken, substantial addition of pixels other than G pixels is effected, making it possible to enhance sensitivity and hence S/N ratio of sensitivity. Further, the weighting coefficient can be changed according to the picture-taking mode, making it possible to perform picture-taking under optimum picture-taking conditions.

(14) The imaging device as defined in Clause (11), comprising a picture-taking mode predetermining unit for predetermining either still mode or animation mode and a weighting coefficient predetermining unit for predetermining the weighting coefficient according to the picture-taking mode predetermined by the picture-taking mode predetermining unit.

In accordance with the aforementioned imaging device, signal processing can be effected while distinguishing the generation of animation image data requiring high speed pixel signal reading for smooth image drawing with a high resolution from other cases. Further, the weighting coefficient can be changed by whether or not picture-taking is effected in animation picture-taking mode, making it possible to perform picture-taking under optimum picture-taking conditions.

(15) A digital camera which takes a picture using an imaging device as defined in any one of Clauses (1) to (14).

In accordance with the aforementioned digital camera, an imaging device is used as a digital camera, making it possible to optimize the imaging performance of the digital camera according to the purpose.

(16) A solid-state imaging element signal processing method for generating a multi-color image signal using a solid-state imaging element which comprises a plurality of photoelectric conversion layers each having a plurality of pixels and reads a signal charge out of the pixels in the photoelectric conversion layers as a pixel signal, which solid-state imaging element comprising a first photoelectric conversion layer for absorbing light rays in the green wavelength range to generate a signal charge and at least a second photoelectric conversion layer for absorbing mainly light rays in a wavelength range different from the green wavelength range to generate a signal charge, wherein a signal charge in one pixel in the first photoelectric conversion layer and various signal charges in the corresponding pixel in the second electrode layer at the position corresponding to the one pixel and the surrounding pixels adjacent to the corresponding pixel are each read out and a multi-color pixel signal according to the one pixel is generated on all the pixel positions on the basis of a value according to signal charge in the one pixel in the first photoelectric conversion layer and a value according to the various signal charges in the corresponding pixel in the second photoelectric conversion layer and the surrounding pixels.

In accordance with the aforementioned signal processing method on solid-state imaging element, a pixel signal is generated with the resolution of various pixels in the first photoelectric conversion layer left unchanged and a pixel signal is generated by processing a plurality of pixels corresponding to the second photoelectric conversion layer having little effect on visual resolution, making it possible to enhance S/N ratio of pixel signal while inhibiting the deterioration of visual color resolution even when the brightness of the object to be picture-taken is low. In this manner, the sensitivity balance of photoelectric conversion portions of various hues can be enhanced, making it possible to enhance image quality and sensitivity.

(17) A signal processing method on a multi-layer solid-state imaging element which comprises a laminate of photoelectric conversion layers each having a plurality of pixels and reads a signal charge out of the various pixels in the photoelectric conversion layers to generate a multi-color pixel signal, wherein a solid-state imaging element comprising a G photoelectric conversion layer disposed in the uppermost layer on the light incidence side which absorbs G (green) light to generate a G signal charge according to the amount of the G light, a B photoelectric conversion layer which absorbs B (blue) light to generate a B signal charge according to the amount of the B light and an R photoelectric conversion layer which absorbs R (blue) light to generate an R signal charge according to the amount of the R light is used, a signal charge in the one pixel in the G photoelectric conversion layer and various signal charges in the corresponding pixel in other photoelectric conversion layers at the position corresponding to the one pixel and the surrounding pixels adjacent to the corresponding pixel are each read out and a multi-color pixel signal according to the one pixel is generated on all the pixel positions on the basis of a value according to signal charge in the one pixel in the G photoelectric conversion layer and a value according to various signal charges in the corresponding pixels in the other photoelectric conversion layers and the surrounding pixels.

In accordance with the aforementioned signal processing method on solid-state imaging element, a pixel signal is generated with the resolution of various pixels in the G photoelectric conversion layer left unchanged and a pixel signal is generated by processing a plurality of pixels corresponding to other photoelectric conversion layers, making it possible to enhance the sensitivity balance of photoelectric conversion portions of various hues and hence image quality and sensitivity.

(18) The signal processing method on solid-state imaging element as defined in Clause (17), wherein the signal charge processing involves final addition of various signal charges in the corresponding pixel B (m, n) corresponding to the position of the pixel G (m, n) (in which m and n each are an integer) two-dimensionally aligned in the G photoelectric conversion layers and the surrounding pixels B (m+a, n+b) (in which a and b each are a positive or negative integer) with respect to the pixel G (m, n).

In accordance with the aforementioned signal processing method on solid-state imaging element, various signal charges in the corresponding pixel B (m, n) in the B photoelectric conversion layer corresponding to the position of pixel G (m, n) and in the surrounding pixels B (m+a, n+b) are finally added. In this manner, adjacent pixels are added, making it possible to enhance sensitivity and hence S/N ratio of signal.

(19) The signal processing method on solid-state imaging element as defined in Clause (17) or (18), wherein the signal charge processing involves final addition of various signal charges in the corresponding pixel R (m, n) corresponding to the position of the pixel G (m, n) (in which m and n each are an integer) two-dimensionally aligned in the G photoelectric conversion layers and the surrounding pixels R (m+a, n+b) (in which a and b each are a positive or negative integer) with respect to the pixel G (m, n).

In accordance with the aforementioned signal processing method on solid-state imaging element, various signal charges in the corresponding pixel R (m, n) in the B photoelectric conversion layer corresponding to the position of pixel G (m, n) and in the surrounding pixels R (m+a, n+b) are finally added. In this manner, adjacent pixels are added, making it possible to enhance sensitivity and hence S/N ratio of signal.

(20) The signal processing method on solid-state imaging element as defined in any one of Clauses (17) to (19), wherein the addition of signal charges involves mixing of charges accumulated in the various pixels in the photoelectric conversion layers.

In accordance with the aforementioned imaging device, charges accumulated in various pixels are mixed, making it possible to eliminate the subsequent signal processing during the formation of image signal.

(21) The signal processing method on solid-state imaging element as defined in any one of Clauses (17) to (19), wherein the addition of signal charges involves addition of pixel signals generated on the basis of signal charges in the various pixels in the photoelectric conversion layers.

In accordance with the aforementioned imaging device, pixel signals generated on the basis of signal charges in various pixels can be added by a simple processing.

(22) The signal processing method on solid-state imaging element as defined in any one of Clauses (17) to (21), wherein the signal charge processing involves multiplication of each of the corresponding pixels and the surrounding pixels by a weighting coefficient according to the pixel position.

In accordance with the aforementioned signal processing method on solid-state imaging element, the corresponding pixel corresponding to the position of pixel to be processed and the surrounding pixels are each multiplied by the weighting coefficient according to the position of pixel, making it possible to give an independent degree of weighting according to the position of pixel. Accordingly, it can be arbitrarily predetermined whether or not pixel signals from pixels other than the pixel to be processed should be added or, if so, what degree they should be added.

(23) The signal processing method on solid-state imaging element as defined in Clause (22), wherein the weighting coefficient is predetermined according to the purpose of picture-taking.

In accordance with the aforementioned signal processing method on the solid-state imaging element, the weighting coefficient is predetermined according to the purpose of picture-taking, making it possible to perform picture-taking under optimum conditions suitable for the purpose of picture-taking.

(24) The signal processing method on solid-state imaging element as defined in Clause (22) or (23), wherein the weighting coefficient is predetermined great for the corresponding pixel but small for the surrounding pixels.

In accordance with the aforementioned signal processing method on solid-state imaging element, the weighting coefficient is predetermined greater for the corresponding pixel but smaller for the surrounding pixels. In this manner, a pixel signal is generated with a great reflection of value of the pixel to be processed but a small reflection of value of the surrounding pixels. Further, the degree of blurring of image quality can be adjusted by the magnitude of the weighting coefficient, making it possible to optimize the imaging performance.

(25) The signal processing method on solid-state imaging element as defined in Clause (22) or (23), wherein the higher the brightness of the object to be picture-taken is, the more is predetermined the weighting coefficient for the corresponding pixel greater than that for the surrounding pixels and the lower the brightness of the object to be picture-taken is, the smaller is predetermined the difference between the weighting coefficient for the corresponding pixel and the weighting coefficient for the surrounding pixels.

In accordance with the aforementioned signal processing method on solid-state imaging element, the higher the brightness of the object to be picture-taken is, the greater is predetermined the weighting coefficient of the corresponding pixel more than that of the surrounding pixels, whereby the degree of blurring is reduced. The lower the brightness of the object to be picture-taken is, the smaller is predetermined the difference between the weighting coefficient of the corresponding pixel and the weighting coefficient of the surrounding pixels, whereby the degree of blurring is raised. In this arrangement, in the case of high brightness, substantial addition of pixels is inhibited to enhance resolution. In the case of low brightness, substantial addition of pixels is effected to enhance sensitivity, making it possible to enhance S/N ratio of pixel signal.

(26) The signal processing method on solid-state imaging element as defined in Clause (22) or (23), wherein the weighting coefficient for the corresponding pixel is predetermined greater than that for the surrounding pixels in the case of still picture-taking while the difference between the weighting coefficient for the corresponding pixel and the weighting coefficient for the surrounding pixels is predetermined small in the case of animated picture-taking.

In accordance with the aforementioned signal processing method on solid-state imaging element, in the case of still image picture-taking, the weighting coefficient of the corresponding pixel is predetermined greater than that of the surrounding pixels to reduce the degree of blurring. In the case of animation picture-taking, the difference between the weighting coefficient of the corresponding pixel and the weighting coefficient of the surrounding pixels is predetermined small to raise the degree of blurring. In this arrangement, in the case of still image picture-taking, substantial addition of pixels is inhibited to enhance resolution. In the case of animation picture-taking, substantial addition of pixels is effected to reduce the number of pixels per frame, making it possible to perform high speed processing.

(27) A digital camera controlling method comprising performing imaging using a signal processing method on solid-state imaging element as defined in any one of Clauses (16) to (26).

In accordance with the aforementioned digital camera controlling method, imaging is effected according to a signal processing method on solid-state imaging element, making it possible to optimize the imaging performance of the digital camera according to the purpose.

In accordance with the invention, even when the brightness of the object to be picture-taken is low, S/N ratio of pixel signal can be enhanced while inhibiting the deterioration of visual color resolution. In this manner, the sensitivity balance of photoelectric conversion portions of various hues can be enhanced, making it possible to enhance image quality and sensitivity. Accordingly, even when the photoelectric conversion portion is a laminated solid-state imaging element, there occurs no deterioration of image quality due to the reduction of the amount of light that reaches the underlying photoelectric conversion portions. Further, even when the photoelectric conversion portion is a multi-plate solid-state imaging element, arrangement can be made such that the properties of the various photoelectric conversion portions can be exhibited without any waste. By selectively or automatically predetermining the processing of charges in the photoelectric conversion portions with a plurality of pixels with respect to light rays other than G light according to the picture-taking conditions, etc., an image data having a quality desired by the user can be formed.

### BRIEF DESCRIPTION OF THE DRAWINGS

FIG. 1 is a diagrammatic plan view of a solid-state imaging element illustrating an embodiment 1-1 of implementation of the invention;

FIG. 2 is a diagrammatic sectional view taken on line I-I of FIG. 1;

FIG. 3 is a diagrammatic sectional view of the solid-state imaging element illustrating the embodiment 1-1 of implementation of the invention with a microlens mounted thereon;

FIG. 4 is a diagrammatic sectional view of the solid-state imaging element illustrating the embodiment 1-1 of implementation of the invention with a microlens mounted thereon;

FIG. 5 is a diagram illustrating another example of alignment of photoelectric conversion elements and signal charge accumulating portions in the solid-state imaging element illustrating the embodiment 1-1 of implementation of the invention with a microlens mounted thereon;

FIG. 6 is a diagram illustrating other example of alignment of photoelectric conversion elements and signal charge accumulating portions in the solid-state imaging element illustrating the embodiment 1-1 of implementation of the invention with a microlens mounted thereon;

FIG. 7 is a diagram illustrating a schematic configuration of a digital camera illustrating the embodiment 1-1 of implementation of the invention;

FIGS. 8A and 8B are diagrams illustrating the mapping of color signals obtained from the solid-state imaging element for illustrating the embodiment 1-1 of implementation of the invention on a memory;

FIGS. 9A to 9C are diagrams illustrating a process of generating a color image data;

FIGS. 10A and 10C are diagrams illustrating a coefficient for use in the process of generating a color image data;

FIG. 11 is a diagram illustrating another example of alignment of solid-state imaging elements for illustrating the embodiment 1-1 of implementation of the invention;

FIG. 12 is a diagram illustrating the mapping of color signals obtained from another configuration of alignment of the solid-state imaging elements for illustrating the embodiment 1-1 of implementation of the invention on a memory;

FIG. 13 is a schematic sectional view illustrating other example of alignment of solid-state imaging elements illustrating the embodiment 1-1 of implementation of the invention;

FIGS. 14A and 14B are diagrams illustrating the mapping of color signals obtained from the solid-state imaging elements for illustrating an embodiment 1-2 of implementation of the invention on a memory;

FIG. 15 is a flow chart illustrating signal processing in the embodiment 1-2 of implementation of the invention;

FIG. 16 is a diagram illustrating signal processing in the embodiment 1-2 of implementation of the invention;

FIG. 17 is a diagram illustrating signal processing in the embodiment 1-2 of implementation of the invention;

FIGS. 18A to 18C are diagrams illustrating signal processing in the embodiment 1-2 of implementation of the invention; and

FIGS. 19A and 19B are diagrams illustrating an example of the coefficient for use in the signal processing in the embodiment 1-2 of implementation of the invention.

FIG. 20 is a flow chart illustrating a modification of the signal processing in the embodiment 1-2 of implementation of the invention;

FIG. 21 is a flow chart illustrating a modification of signal processing in the embodiment 1-2 of implementation of the invention; and

FIG. 22 is a diagram illustrating a modification of the signal processing method in the embodiment 1-2 of implementation of the invention.

FIG. 23 is a diagrammatic sectional view of a one pixel portion of a multi-layer solid-state imaging element according to an embodiment 2-1 of implementation of the solid-state imaging element of the invention;

FIG. 24 is a conceptional block diagram of a imaging device comprising a solid-state imaging element;

FIG. 25 is a view diagrammatically illustrating the pixel of a solid-state imaging element;

FIG. 26 is a diagram illustrating a specific example of pixel addition on 3×3 pixel alignment wherein FIG. 26A depicts G pixel, FIG. 26B depicts B pixel and FIG. 26C depicts R pixel;

FIG. 27A is a diagram illustrating a mask pattern involving no pixel addition, FIG. 27B is a mask pattern involving three-time pixel addition and FIG. 27C is a mask pattern involving nine-time pixel addition;

FIG. 28 is a diagram illustrating how the points to be processed for pixel addition are moved wherein FIG. 28A depicts G signal and FIGS. 28B and 28C depict B signal and R signal, respectively;

FIG. 29 is a diagram illustrating the procedure of generating pixel signals in the case of charge mixing wherein FIGS. 29A, 29B and 29C depict G signal, B signal and R signal in the various pixels, respectively;

FIG. 30 is a configurational diagram illustrating an example of an imaging device according to a fourth embodiment;

FIG. 31 is a flow chart illustrating the procedure of effecting pixel addition according to picture-taking mode; and

FIG. 32 is a flow chart illustrating the procedure of effecting charge mixing according to picture-taking mode.

### DETAILED DESCRIPTION OF THE INVENTION

Embodiments of implementation of the invention will be described in connection with the attached drawings.

### Embodiment 1-1

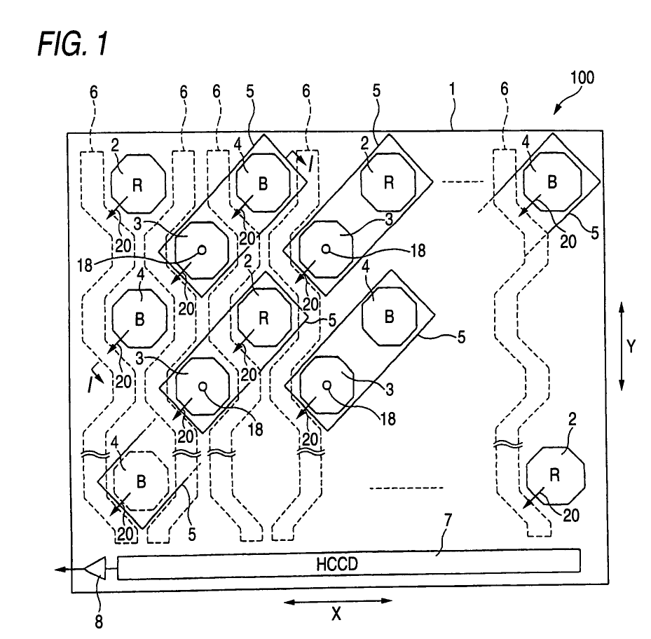

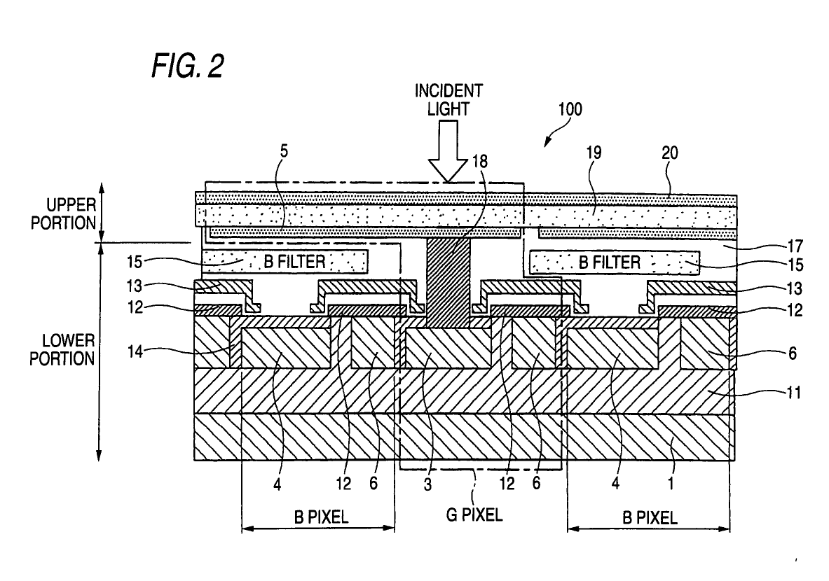

FIG. 1 is a diagrammatic plan view of a solid-state imaging element 100 for explaining an embodiment 1-1 of implementation of the invention. FIG. 2 is a diagrammatic sectional view taken on line I-I of FIG. 2.

On the surface portion of a semiconductor substrate 1 are aligned a plurality of photoelectric conversion elements 2, 4 made of silicon and a plurality of signal charge accumulating portions 3 in the line direction (X direction in FIG. 1) and in the row direction (Y direction in FIG. 1), respectively. In the present embodiment, the total number of the photoelectric conversion elements 2 and 4 is predetermined to be the same as the number of the signal charge accumulating portions 3. The number of the signal charge accumulating portions 3 is the same as the maximum number of pixel data in color image data that can be generated on the basis of a color signal obtained from the solid-state imaging element 100.

As shown in FIG. 1, in each odd line, a plurality of photoelectric conversion elements (photodiode which will be hereinafter referred to as “R photoelectric conversion element”) 2 which each detect red color (R) and generates and accumulates red signal charge corresponding thereto and a plurality of photoelectric conversion elements (photodiode which will be hereinafter referred to as “B photoelectric conversion element”) 4 which each detect blue color (B) and generates and accumulates blue signal charge corresponding thereto are alternately aligned. In each even line, a plurality of signal charge accumulating portions 3 (accumulating diode) which each accumulate green signal charge are aligned. Odd lines which each begin with the alignment of R photoelectric conversion element 2 and which each begin with the alignment of B photoelectric conversion element 4 are alternately aligned in the row direction. The odd lines and the even lines are aligned apart from each other in the line direction at a dimension of substantially half the line alignment pitch thereof.

Above the surface of the semiconductor substrate 1 is laminated a photoelectric conversion layer 19 (see FIG. 2) which detects green light and generates and accumulates green signal charge corresponding thereto. A pixel electrode layer 5 provided under the photoelectric conversion layer 19 is disposed to cover the signal charge accumulating portion 3 and the R photoelectric conversion element 2 or B photoelectric conversion element 4 disposed adjacent thereto. The photoelectric conversion layer 19 is composed of an organic material.

On the surface portion of the semiconductor substrate 1 are provided vertical transmission channels 6 (vertical CCD) through which signal charge accumulated in the photoelectric conversion elements 2, 4 and the signal charge accumulating portions 3 are transmitted in Y direction. On the side of the semiconductor substrate 1 which is lower as viewed on the drawing are provided a horizontal transmission channel 7 (horizontal CCD) through which the signal charge transmitted through the vertical transmission channels 6 is transmitted in X direction and an outputting portion 8 which outputs a color signal according to the signal charge transmitted through the horizontal transmission channel 7. The vertical transmission channels 6, the horizontal transmission channel 7 and the outputting portion 8 constitute the signal reading circuit defined in the claims.

Two vertical transmission channels 6 are provided interposed between the photoelectric conversion elements 2 and 4 aligned in X direction and between the signal charge accumulating portions 3 aligned in X direction. The vertical transmission channels 6 each extend in Y direction and zigzag through the gap between the row of photoelectric conversion elements and the row of signal charge accumulating portions.

In this arrangement, the vertical transmission channels 6 which are disposed adjacent thereto in X direction can be disposed interposed between the photoelectric conversion elements or between the signal charge accumulating portions. Therefore, a wiring connecting between the vertical transmission channels can be provided at the portion where the vertical transmission channels are disposed adjacent thereto. Accordingly, the signal charge transmission capacity of the vertical transmission channels 6 can be raised as compared with configurations such as interline CCD. Further, the rise of the amount of signal charge accumulated in the photoelectric conversion elements 2, 4 or the signal charge accumulating portions 3 can be sufficiently coped with.

For the details of the configuration of the vertical transmission channel 6 shown in FIG. 1, reference can be made to JP-A-10-136391.

The signal charge accumulated in the R photoelectric conversion element 2, the signal charge accumulating portion 3 and the B photoelectric conversion element 4 are each read out at a reading gate 20 (diagrammatically represented by the arrow in FIG. 1) to the vertical transmission channel 6 through which they are then transmitted to the horizontal transmission channel 7 through which they are then transmitted to the outputting portion 8 from which color signals (red signal, green signal, blue signal) according to the various signal charges are then outputted. In this manner, red signal, green signal and blue signal are read out of the solid-state imaging element 100.

The reading gate 20 of the R photoelectric conversion element 2, the B photoelectric conversion element 4 and the signal charge accumulating portion 3 are provided on the side of the R photoelectric conversion element 2, the B photoelectric conversion element 4 and the signal charge accumulating portion 3, respectively, close to the vertical transmission channel 6 disposed on the left side thereof. In other words, the vertical transmission channel 6 disposed on the left side of the signal charge accumulating portion 3 is a transmission channel dedicated to transmit only green signal charge and the vertical transmission channel 6 disposed on the left side of the photoelectric conversion elements 2 and 4 are transmission channels dedicated to transmit only red and blue signal charges, respectively.

As shown in FIG. 2, on the surface of the n-type semiconductor substrate 1 is formed a p-well layer 11. In the blue (B) pixel region in the surface portion of the p-well layer 11 is formed an n region 4. A photodiode is formed as a B photoelectric conversion element 4 interposed between the p-well layer 11 and the n region 4. The signal charge thus generated is accumulated in the n region 4.

In the embodiment shown, an n region 3 is formed in the surface portion of the p-well layer 11 formed between the two n regions 4. The n region 3 acts as a green signal charge accumulating portion 3. On the right side of the n regions 3 and 4, an n region 6 is provided somewhat apart from the n regions 3 and 4, respectively. These n regions 6 each constitute the vertical transmission channel 6 shown in FIG. 1. On the surface portion of the n region 6 is formed a transmission electrode which acts also as a reading electrode 12 extending to the n regions 3, 4. On the various transmission electrodes is provided a light-shielding layer 13. The portion of the p-well layer 11 on which the reading electrode 12 is superposed corresponds to the reading gate 20 of FIG. 1.

A p+ region 14 is provided extending over the left side and the surface portion of the various n regions 3, 4 to isolate the n regions 3, 4 from the adjacent vertical transmission channel 6 and lower the defect level of the surface portion. On the outermost surface of the semiconductor substrate 1 is formed a silicon oxide layer (not shown) on which the transmission electrode 12 is formed.

On the opening of the light-shielding layer 13 disposed above the n region 4 is provided a color filter 15 which transmits blue light. The color filter 15, the light-shielding layer 13 and the transmission electrode 12 are embedded in a transparent insulating layer 17.

On the surface of the insulating layer 17 is divisionally provided the transparent pixel electrode layer 5 described in FIG. 1. The various pixel electrode layers 5 and the n regions 3 are connected to each other via a vertical wiring 18. The vertical wiring 18 is electrically insulated from the portions other than the pixel electrode layers 5 and the n regions 3 to which it is connected. On the vertical wiring 18 is laminated a photoelectric conversion layer 19 extending all over the entire surface of the semiconductor substrate 1 on which a common transparent counter electrode layer 20 is formed. The pixel electrode layer 5 determines the photoelectric conversion region in the photoelectric conversion layer 19. The region of the photoelectric conversion layer 19 disposed interposed between the counter electrode layer 20 and the pixel electrode layer 5 acts as a photoelectric conversion region. A signal charge generated in the photoelectric conversion region is accumulated in the signal charge accumulating portion 3.

FIG. 2 illustrates a sectional view of the portion including the B photoelectric conversion element 4 and the signal charge accumulating portion 3. However, since the section of the portion including the R photoelectric conversion element 2 and the signal charge accumulating portion 3 has the same configuration as that of the portion including the B photoelectric conversion element 4 and the signal charge accumulating portion 3 except that the n region 4 is replaced by the n region 2 and the color filter 15 is replaced by a red color filter which transmits red light, in FIG. 2, the description thereof is omitted.

When light rays are incident on the solid-state imaging element 100 having the aforementioned configuration, the light rays having a green wavelength region among the incident light rays are absorbed by the photoelectric conversion layer 19 to generate a green signal charge in the photoelectric conversion layer 19. When a bias potential is applied to the pixel electrode layer 5, the green signal charge flows through the vertical wiring 18 into the n region 3 in which it is then accumulated.

The light rays having red (R) and blue (B) wavelength regions among the incident light rays are transmitted by the photoelectric conversion layer 19. The red light rays are transmitted by the red color filter, and then enter the n region 2. In this manner, a signal charge according to the amount of red light rays are generated and accumulated in the n region 2. Similarly, the blue light rays are transmitted by the color filter 15, and then enter the n region 4. In this manner, a signal charge according to the amount of blue light rays are generated and accumulated in the n region 4.

When a high potential is applied to the reading electrode 12, the red, green and blue signal charges accumulated in the n regions 2, 3 and 4, respectively, are read out to the respective vertical transmission channel 6. These signal charges are each transmitted through the respective vertical transmission channel 6 to the horizontal transmission channel 7 through which they are then transmitted to the outputting portion 8 from which color signals according to the various signal charges are then outputted.

As mentioned above, in accordance with the solid-state imaging element 100 according to the present embodiment, the charge transmission capacity of the vertical transmission channels 6 can be raised from that of interline type CCD. The employment of a vertical transmission channel having a high charge transmission capacity as a signal reading circuit in the solid-state imaging element 100 having the configuration as shown in FIG. 2 leads to the enhancement of the area of the pixel electrode layer 5 or the size of the photoelectric conversion element, making it possible to generate a color image data having a higher quality.

Further, in accordance with the solid-state imaging element 100 according to the present embodiment, the signal reading process of the existing CCD type image sensor can be applied as it is, making it possible to reduce the production cost.

Moreover, the solid-state imaging element 100 according to the present embodiment can be produced merely by utilizing the design of the existing single-plate color CCD image sensor or CMOS image sensor as it is to produce the semiconductor substrate 1, forming the vertical wiring 18 instead of the green color filter needed to be provided in the existing sensor and forming the pixel electrode layer 5, the photoelectric conversion layer 19 and the counter electrode layer 20 as upper layers, making it possible to reduce the production cost.

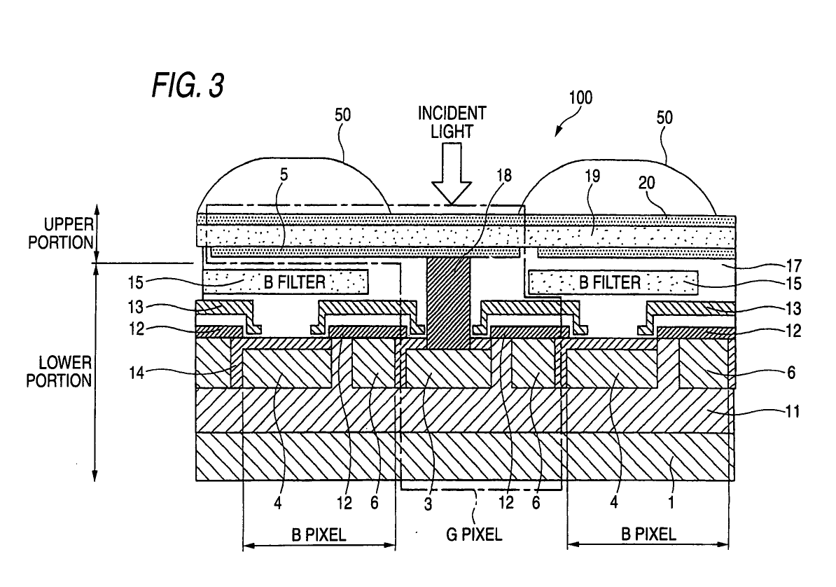

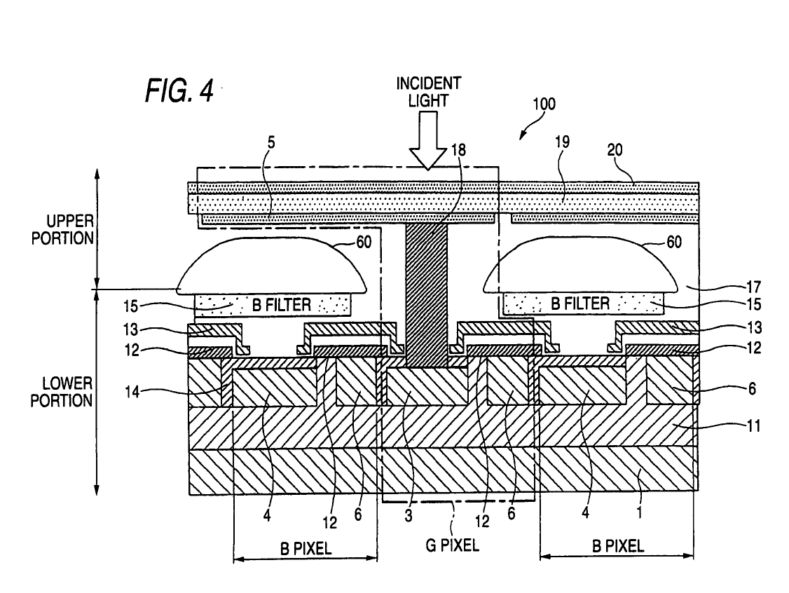

In the solid-state imaging element 100 of the present embodiment, a microlens 50 is preferably mounted on the top of the counter electrode layer 20 as shown in FIG. 3 so that red and blue incident light rays are converged to the interior of the opening of the light-shielding layer 13 in the n regions 2 and 4, respectively. Alternatively, a microlens 60 is preferably mounted interposed between the color filter 15 and red color filter and the pixel electrode layer 5 as shown in FIG. 4 so that red and blue incident light rays are converged to the interior of the opening of the light-shielding layer 13 in the n regions 2 and 4, respectively.

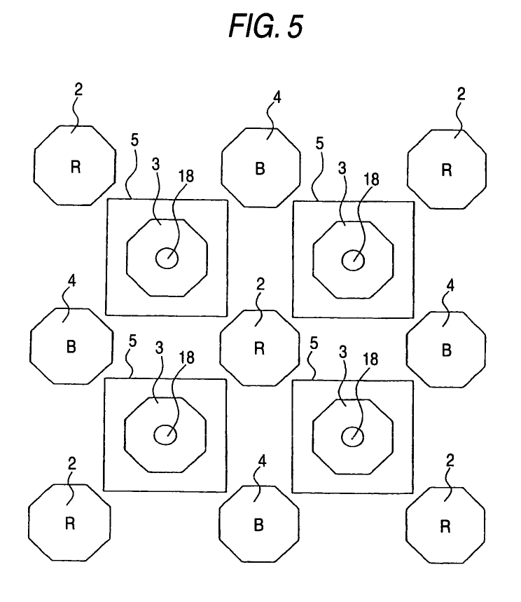

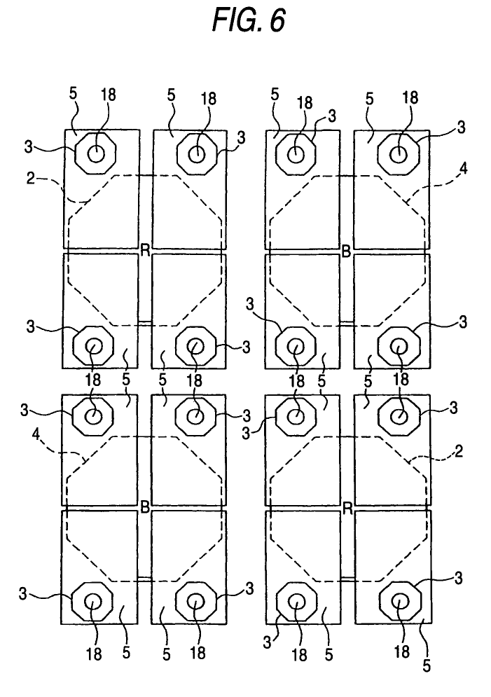

Further, the alignment of the R photoelectric conversion element 2, the B photoelectric conversion element 4 and the signal charge accumulating portion 3 and the size, shape, etc. of the R photoelectric conversion element 2, the B photoelectric conversion element 4 and the pixel electrode layer 5 are not limited to that shown in FIG. 1 but may be as shown in FIG. 5 or 6. In FIGS. 5 and 6, where the parts are the same as those of FIG. 1, the same reference numerals are used.

The configuration shown in FIG. 5 is arranged such that the R photoelectric conversion element 2 and the B photoelectric conversion element 4 are not superposed on the pixel electrode layer 5. In this arrangement, the pixel electrode layer 5 is not superposed on the photoelectric conversion elements 2, 4, giving an advantage that the pixel electrode layer 5 can be formed by an opaque metal such as aluminum and tungsten and thus can be easily produced. The configuration shown in FIG. 5 is also advantageous in that the position of center of gravity of green signal coincides completely with the position of the signal charge accumulating portion 3, allowing easy signal processing.

While the present embodiment has been described with reference to the case where the semiconductor substrate of the solid-state imaging element 100 has two photoelectric conversion elements, i.e., photoelectric conversion element for detecting red light and photoelectric conversion element for detecting blue light, the invention is not limited thereto, but the configuration of the invention may have two or more photoelectric conversion elements provided therein.

While the present embodiment has been described with reference to the case where the signal reading circuit is formed by charge transmission channels as in CCD type image sensors, an MOS transistor for reading out signal may be formed beside the n regions 2, 3 and 4 so that color signals can be read out of the n regions 2, 3 and 4 as in the related art CMOS type image sensors.

In the solid-state imaging element 100, the percent opening of the R photoelectric conversion element 2 and the B photoelectric conversion element 4 provided in the lower portion is slightly lower than that of the photoelectric conversion layer 19 provided in the upper portion as shown in FIG. 2. Further, when a predetermined amount of light rays are incident on the solid-state imaging element 100, the amount of light rays incident on the R photoelectric conversion element 2 and the B photoelectric conversion element 4 provided in the lower portion is smaller than that of light rays incident on the photoelectric conversion layer 19 due to the effect of the color filter, the light-shielding layer 13, the vertical wiring 18, the percent opening, etc. Accordingly, the sensitivity of color signal obtained in the upper layer and the sensitivity of color signal in the lower layer show some scatter. Further, the S/N ratio (signal-to-noise ratio) of color signal obtained in the lower portion is deteriorated. Thus, when the color signal obtained from the solid-state imaging element 100 is used, the resulting color image data is deteriorated. A imaging device capable of preventing the scatter of sensitivity or the deterioration of S/N ratio will be described hereinafter.

The imaging device to be used to describe the first embodiment of implementation of the invention is capable of taking a picture of an object to generate a color image data and is a digital camera, for example.

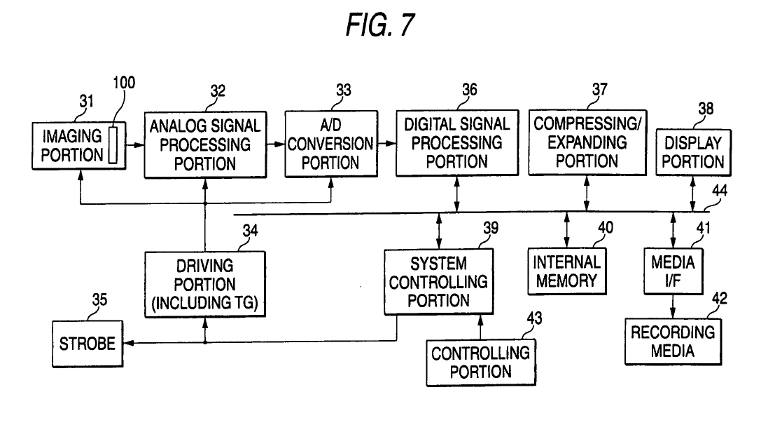

FIG. 7 is a diagram illustrating a schematic configuration of a digital camera to be used to describe the embodiment 1-1 of implementation of the invention.

The digital camera of FIG. 7 comprises an imaging portion 31, an analog signal processing portion 32, an A/D conversion portion 33, a driving portion 34, a strobe 35, a digital signal processing portion 36 (corresponding to the color signal generating unit defined in the claims), a compressing/expanding portion 37, a display portion 38, a system controlling portion 39, an internal memory 40, a media interface 41, a recording media 42 and an operating portion 43. The digital signal processing portion 36, the compressing/expanding portion 37, the display portion 38, the system controlling portion 39, the internal memory 40 and the media interface 41 are connected to a system bus 44.

The imaging portion 31 uses an optical system such as picture-taking lens and the solid-state imaging element 100 shown in FIG. 1 to take a picture of an object and output analog color signals (red signal, blue signal, green signal). The analog signal processing portion 32 is adapted to subject the color signal obtained in the imaging portion 31 to analog signal processing. The A/D conversion portion 33 is adapted to subject the analog color signals obtained in the analog signal processing portion 32 to digital conversion.

In the picture-taking operation, the optical system and the solid-state imaging element 100 are controlled via the driving portion 34. When triggered by ON of a release switch (not shown) made by depressing a release button (not shown) as a part of the operating portion 43, the solid-state imaging element 100 is driven at a predetermined timing by a driving signal from a timing generator (represented by “TG” in FIG. 7) incorporated in the driving portion 34 to output analog color signals according to signal charge accumulated in the R photoelectric conversion element 2, the B photoelectric conversion element 4 and the signal charge accumulating portion 3 to the analog signal processing 32. While the present embodiment has been described with reference to the case where the reading of color signals from the solid-state imaging element 100 is carried out by an interlace reading process involving the reading of the solid-state imaging element 100 in two portions, i.e., odd line and even line, a progressive reading process involving the simultaneous reading of odd line and even line may be employed. The driving portion 34 is controlled by the system controlling portion 39 to output a predetermined driving signal.

The digital signal processing portion 36 is adapted to subject the digital color signal from the A/D conversion portion 33 to digital signal processing according to the operation mode predetermined by the operating portion 43. Examples of processing made by the digital signal processing portion 36 include black level correction (OB processing), linear matrix correction, white balance adjustment, gamma correction, color image data generation, and Y/C conversion. The digital signal processing portion 36 is formed by, e.g., DSP.

The compressing/expanding portion 37 is adapted to compress Y/C data obtained in the digital signal processing portion 36 and expand the compressed image data obtained in a recording media 42.

The display portion 38 comprises, e.g., an LCD display unit and displays a color image based on the color image data obtained by subjecting the image data taken to digital signal processing. The display portion 38 also displays an image based on the image data obtained by expanding the compressed image data recorded in the recording media 42. The display portion 38 further can display through image during picture taking, various conditions of digital camera, data on operation, etc.

The internal memory 40 is DRAM for example. The internal memory 40 is used as a work memory for the digital signal processing portion 36 or the system controlling portion 39. The internal memory 40 is used also as a buffer memory which temporarily stores the image data to be recorded in the recording media 42 or a buffer memory for image data to be displayed on the display portion 38. The media interface 41 is adapted to input data to the recording media 42 such as memory card and output data from the recording media 42.

The system controlling portion 39 is mainly composed of a processor which uses a predetermined program to operate and is adapted to control the entire digital camera, including picture-taking operation.

The operating portion 43 performs various operations during the use of digital camera.

In operation of the digital camera shown in FIG. 7, as the green signal constituting one-pixel data in color image data there is used the green signal obtained from the upper portion of the solid-state imaging element 100 as it is. Concerning the red signal and blue signal constituting one-pixel data in color image data, the red signal and blue signal obtained from the lower portion are used to generate red signals and blue signals in a number corresponding to the number of pixels in the color image data. In this manner, a color image data is generated. In some detail, the digital camera according to the present embodiment is adapted to perform the same processing as digital camera which uses two solid-state imaging elements, i.e., solid-state imaging element which outputs only green signals in a number corresponding to the number of pixels in color image data and solid-state imaging element which outputs only red signals and blue signals in a number corresponding to the number of pixels in color image data. The digital camera according to the present embodiment is adapted to perform the same processing as digital camera comprising a known two-plate or three-plate CCD type image sensor to generate a color image data.

The operation of the digital camera shown in FIG. 7 will be described hereinafter.

When the release switch is turned ON, the driving portion 34 drives the solid-state imaging element 100 to take a picture of an object. Firstly, red signals and blue signals according to signal charge accumulated in the R photoelectric conversion element 2 and the B photoelectric conversion element 4 are outputted from the solid-state imaging element 100 to the analog signal processing 32. Subsequently, blue signals according to signal charge accumulated in the signal charge accumulating portion 3 are outputted from the solid-state imaging element 100 to the analog signal processing 32. The red signals, blue signals and green signals are inputted to the digital signal processing portion 36 via the analog signal processing 32 and the A/D conversion portion 33.

The digital signal processing portion 36 is adapted to map the red signals, blue signals and green signals thus inputted on the internal memory 40 in correspondence to the position of the n regions 2, 3 and 4, respectively, in which these signals are obtained.

The process of generating a color image data from the digital signal processing portion 36 using a color signal obtained from photoelectric conversion elements in three rows and three lines, totaling 9, mainly composed of photoelectric conversion element 2 or 4 corresponding to one-pixel data in color image data and a color signal obtained from photoelectric conversion elements 3 in three rows and three lines, totaling 9, mainly composed of photoelectric conversion element 3 corresponding to one-pixel data in color image data will be described hereinafter.

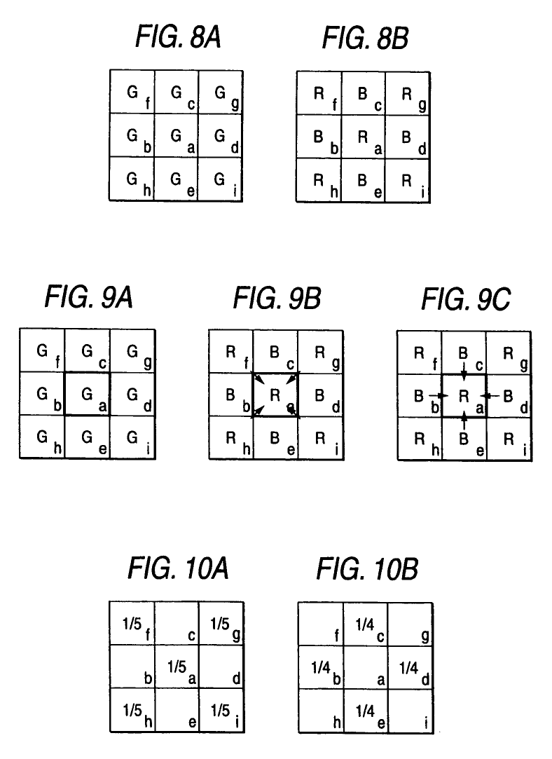

FIG. 8 is a diagram illustrating color signals mapped on the internal memory 40. FIG. 8A is a diagram illustrating the mapping of color signals (represented by “G” in the drawing) obtained from 9 signal charge accumulating portions mainly composed of signal charge accumulating portion 3 corresponding to one-pixel data in color image data. FIG. 8B is a diagram illustrating the mapping of color signals (red signal and blue signal are represented by “R” and “B”, respectively, in the drawing) obtained from 9 signal charge accumulating portions mainly composed of signal charge accumulating portion 2 corresponding to one-pixel data in color image data. While the configuration shown in FIG. 1 has been described with reference to the case where the position of center of gravity of green signal actually corresponds to the central position of the pixel electrode layer 5, the present embodiment is described with reference to the case where the position of center of gravity of green signal corresponds to the position of the signal charge accumulating portion 3.

In FIG. 8, the point corresponding to one-pixel data in color image data in each color signal is defined to be a sample point. These sample points are given reference numerals a to i.

The digital signal processing portion 36 is adapted to provide the sample points shown in FIG. 8 with three color signals, i.e., red signal, blue signal, green signal and generate one-pixel data.

The signal processing by which color image data is generated at the various sample points will be described hereinafter.

As green signal is present on these sample points. The green signal is obtained in a sufficient amount as mentioned above at a high S/N ratio. Thus, the digital signal processing portion 36 uses the green signal at the various sample points as it is to form a green signal constituting one-pixel data (see FIG. 9A).

The red signal and blue signal each are a color signal according to signal charge accumulated in the R photoelectric conversion element 2 and the B photoelectric conversion element 4 and thus are present in a small amount at a low S/N ratio as mentioned above.

Therefore, the digital signal processing portion 36 uses a red signal present on the sample point having red signal and a red signal present on the sample point adjacent thereto (signal from the photoelectric conversion element which detects the same color as detected by the photoelectric conversion element aligned adjacent to the photoelectric conversion element from which a signal present on the sample point is obtained) to generate a red signal constituting one-pixel data in the sample point having a red signal (see FIG. 9B).

For example, various signals present on the sample point a and the sample points f to i adjacent thereto are multiplied by a predetermined coefficient. The signal obtained by integrating the products is defined to be a red signal constituting one-pixel data at the sample point a. This coefficient may be any numerical value such as ⅕ (see FIG. 10A) and 1.

In the case where the coefficient is ⅕, the amount of red signal present on the newly generated sample point a is substantially the same as the amount of red signal obtained from one R photoelectric conversion element 2, making it impossible to raise the sensitivity of red signal cannot be raised while making it possible to raise the S/N ratio by that amount. On the other hand, in the case where the coefficient is 1, the amount of red signal present on the newly generated sample point a can be 5 times the amount of red signal obtained from one R photoelectric conversion element 2, making it possible to raise the sensitivity of red signal cannot be raised while deteriorating the S/N ratio by that amount.

Similarly, the digital signal processing portion 36 uses a blue signal present on the sample point having blue signal and a blue signal present on the sample point adjacent thereto (signal from the photoelectric conversion element which detects the same color as detected by the photoelectric conversion element aligned adjacent to the photoelectric conversion element from which a signal present on the sample point is obtained) to generate a blue signal constituting one-pixel data in the sample point having a blue signal.

Subsequently, the digital signal processing portion 36 subjects the sample point free of red signal or blue signal constituting one-pixel data to processing for interpolation of red signal or blue signal constituting one-pixel data. This interpolation can be carried out by various known methods. In order to interpolate blue signal in the sample point a, various blue signals present on the sample points b to e surrounding the sample point a are multiplied by a predetermined coefficient. The signal obtained by integrating the products of these blue signals by the coefficient is defined to be a blue signal constituting one-pixel data at the sample point a. This coefficient may be any numerical value such as ¼ (see FIG. 10B) and 1.

Thus, the digital signal processing portion 36 performs a process of providing the various sample points with red signal, blue signal and green signal each constituting one-pixel data, respectively.

The generation of red signal and blue signal constituting a color image data makes it possible to determine which is prior to the other sensitivity or S/N according to the operating mode of the digital camera. For example, in the case where picture is taken at a highly predetermined photographic ISO sensitivity or in a scene having an insufficient luminance, as the aforementioned coefficient there can be used 1 so that a color image data having a raised sensitivity is generated. In the case where picture is taken at a low photographic ISO sensitivity or in a scene having too high a luminance, as the aforementioned coefficient there can be used ¼ or ⅕ so that a color image data having a good S/N ratio is generated.

Supposing that the coordinates of the sample points on the map are (m, n) with the sample point a as origin, the aforementioned process for generating red signal, blue signal and green signal constituting one-pixel data on the sample point having blue signal is represented by the following numerical formula.

In the following numerical formula, k (m, n) is the coefficient predetermined for the sample point having coordinates (m, n), g (m, n) is green signal (green signal obtained from the signal charge accumulating portion 3 corresponding to one-pixel data) before the generation of one-pixel data on the sample point having coordinates (m, n), b (m, n) is blue signal (blue signal obtained from the B photoelectric conversion element 4 corresponding to one-pixel data) before the generation of one-pixel data on the sample point having coordinates (m, n), r (m, n) is red signal (red signal obtained from the R photoelectric conversion element 2 corresponding to one-pixel data) before the generation of one-pixel data on the sample point having coordinates (m, n), G (m, n) is green signal before the generation of one-pixel data on the sample point having coordinates (m, n), B (m, n) is blue signal before the generation of one-pixel data on the sample point having coordinates (m, n), and R (m, n) is red signal before the generation of one-pixel data on the sample point having coordinates (m, n).
G(m,n)=g(m,n)
B(m,n)=k(m,n+1)*b(m,n+1)+k(m−1,n)*b(m−1,n)+k(m+1,n)*b(m+1,n)+k(m,n−1)*b(m,n−1)
R(m,n)=k(m−1,n+1)*r(m−1,n+1)+k(m+1,n+1)*r(m+1,n+1)+k(m,n)*r(m,n)+k(m−1,n−1)*r(m−1,n−1)+k(m+1,n−1)*r(m+1,n−1)

However, b (m, n) is blue signal newly generated after addition.

On the other hand, the aforementioned process for generating red signal, blue signal and green signal constituting one-pixel data on the sample point having blue signal is represented by the following numerical formula.
G(m,n)=g(m,n)
B(m,n)=k(m−1,n+1)*b(m−1,n+1)+k(m+1,n+1)*b(m+1,n+1)+k(m,n)*b(m,n)+k(m−1,n−1)*b(m−1,n−1)+k(m+1,n−1)*b(m+1,n−1)
R(m,n)=k(m,n+1)*r(m,n+1)+k(m−1,n)*r(m−1,n)+k(m+1,n)*r(m+1,n)+k(m,n−1)*r(m,n−1)

However, r (m, n) is red signal newly generated after addition.

As mentioned above, in accordance with the digital camera of the present embodiment, the sensitivity or S/N ratio of red signal or blue signal constituting each pixel data in color image data generated by taking a picture of an object can be raised, making it possible to generate a high quality color image data.

While the foregoing description has been made with reference to the case where color image data are generated by the digital signal processing portion 36, the processing made by the digital signal processing portion 36 may be effected in the analog signal processing 32. In this case, the analog signal processing 32 may perform the same processing as effected in the digital signal processing portion 36 on analog red signal, blue signal and green signal inputted from the imaging portion 31 to generate analog color image data. Further, the analog signal processing 32 may perform addition of red signals or blue signals using a low pass filter.

While the foregoing description has been made with reference to the case where a color signal outputted from the imaging portion 31 can be subjected to signal processing to generate a high quality color image data, the same effect can be exerted also by controlling the process of reading out the color signal.

In this case, the driving portion 34 may drive the solid-state imaging element 100 such that signal charge accumulated in the photoelectric conversion element corresponding to one-pixel data and signal charge accumulated in the photoelectric conversion element of the same kind adjacent to the former photoelectric conversion element for detecting the same color as that of the former photoelectric conversion element are mixed in the vertical transmission channels 6 and the horizontal transmission channel 7 during the drive/control for reading of a color signal from the solid-state imaging element 100.

For example, when the photoelectric conversion element corresponding to one-pixel data is R photoelectric conversion element 2 which is disposed at 2nd line from left in the 3rd row in the solid-state imaging element 100 shown in FIG. 1, the driving portion 34 controls the timing of drive pulse such that the signal charge accumulated in the R photoelectric conversion element 2 of the same kind and four signal charges accumulated in four R photoelectric conversion elements 2 aligned adjacent to the former photoelectric conversion element 2, respectively, are mixed in the vertical transmission channels 6 and the horizontal transmission channel 7.

Similarly on the B photoelectric conversion element 4, the driving portion 34 controls the timing of drive pulse such that the signal charge accumulated in the B photoelectric conversion element 4 and four signal charges accumulated in four B photoelectric conversion elements 4 of the same kind aligned adjacent to the former photoelectric conversion element 4, respectively, are mixed in the vertical transmission channels 6 and the horizontal transmission channel 7.

The digital signal processing portion 36 may then perform signal interpolation with red signal and blue signal obtained from the solid-state imaging element 100 to generate a color image data together with green signal obtained from the solid-state imaging element 100.

In this case, the number of red signals and blue signals obtained from the solid-state imaging element 100 are each reduced to ⅕, deteriorating the resolution. However, the same effect as exerted when the coefficient to be used in the processing by the digital signal processing portion 36 is 1 can be obtained. Accordingly, high sensitivity red signal, blue signal and green signal can be taken out of the solid-state imaging element 100, making it possible to generate a high quality color image data.

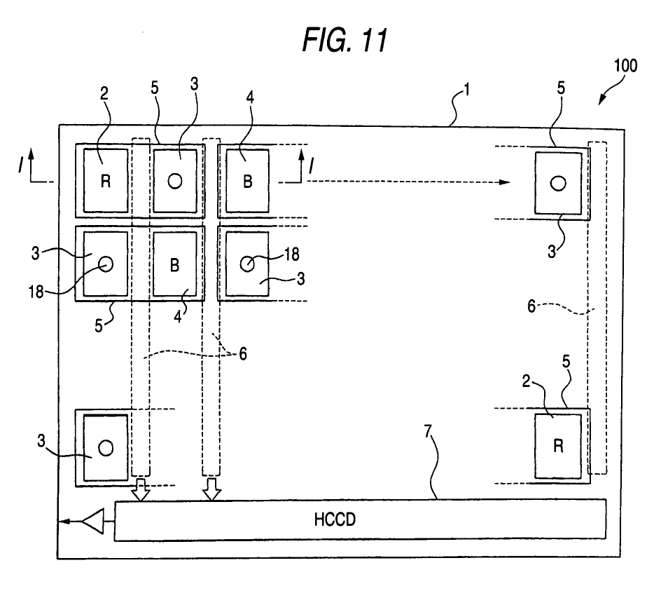

While the foregoing description has been made with reference to the case where the R photoelectric conversion elements 2, the B photoelectric conversion elements 4 and the signal charge accumulating portions 3 are aligned as shown in FIG. 1, the alignment of these components is not limited thereto and may be as shown in FIG. 11. In FIG. 11, where the parts function in the same way as those of FIG. 1, the same reference numerals are used. The sectional view taken on line I-I of FIG. 11 is the same as the sectional view shown in FIG. 2 except that the n region 4 disposed left side is replaced by the n region 2 and the color filter 15 is replaced by a red color filter.

The solid-state imaging element shown in FIG. 11 comprises R photoelectric conversion elements 2, B photoelectric conversion elements 4 and signal charge accumulating portions 3 aligned in the form of square lattice and each aligned checkerwise on the semiconductor substrate 1. The vertical transmission channels 6 each don't extend zigzag but extend linearly in Y direction along the rows.

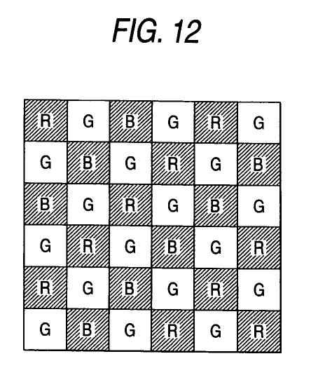

In the solid-state imaging element shown in FIG. 11, in the case where color signals obtained from the R photoelectric conversion elements 2, the B photoelectric conversion elements 4 and the signal charge accumulating portions 3 are mapped on the internal memory as shown in FIG. 12, the digital signal processing portion 36 adds the color signal on the sample points shown shaded in FIG. 12 and the same color signal on the sample point disposed adjacent thereto at a predetermined ratio to generate a color signal having a good sensitivity or S/N ratio. Synchronization or signal interpolation is then conducted with red signal, blue signal and green signal thus generated to provide these sample points with three color R, G and B signals. Thus, a color image data is generated. The configuration of FIG. 11 makes it possible to generate a high quality color image data. At the same time, signal interpolation can be made to realize a high resolution.

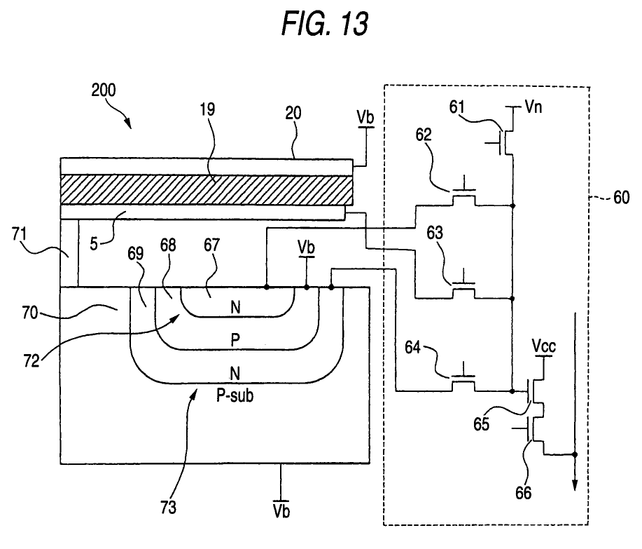

Further, the signal processing or charge mixing for the generation of a color image data described in the present embodiment can be applied to the solid-state imaging element 200 having a configuration as shown in FIG. 13.

FIG. 13 is a schematic sectional view illustrating another solid-state imaging element according to the present embodiment. While only a portion corresponding to one-pixel data in a color image data is shown in FIG. 13, a plurality of the solid-state imaging elements shown in FIG. 13 are actually aligned two-dimensionally on the same plane.

The solid-state imaging element 200 shown in FIG. 13 comprises an N-type semiconductor layer 67, P-type semiconductor layer 68 and an N-type semiconductor layer 69 laminated in this order as viewed from the surface of a P-type semiconductor substrate 70 (e.g., silicon substrate). To the N-type semiconductor layer 67 is connected a MOS transistor 62. To the N-type semiconductor layer 69 is connected a MOS transistor 64. The P-type semiconductor substrate 70 and the P-type semiconductor substrate 68 are each kept at a bias potential Vb.

Above the P-type semiconductor substrate 70 is laminated a photoelectric conversion layer 19 with a supporting portion 71 interposed therebetween, the photoelectric conversion layer 19 being interposed between a pixel electrode layer 5 and a counter electrode layer 20, similarly to the upper portion of the solid-state imaging element 100 shown in FIG. 2. The counter electrode layer 20 is kept at a bias potential Vb. To the pixel electrode layer 5 is connected a MOS transistor 63.

The MOS transistors 62, 63 and 64 are connected to a common reset MOS transistor 61 and a common amplifying MOS transistor 65. To the MOS transistor 65 is connected a MOS transistor 66 for signal selection. These MOS transistors are connected to each other and to the solid-state imaging element 200 with a signal wire. The signal wire with which the MOS transistors 61 to 66 are connected to each other and to the solid-state imaging element 200 constitutes a signal reading circuit 60. The signal reading circuit 60 is formed on a P-type semiconductor substrate 70. The signal reading circuit 60 uses an XY address process to read out color signals.

The depth of the PN junction of the N-type semiconductor layer 67 and the P-type semiconductor layer 68 from the surface of the P-type semiconductor substrate 70 is suitable for the absorption of blue light. Accordingly, the PN junction of the N-type semiconductor layer 67 and the P-type semiconductor layer 68 constitutes between the two regions a photodiode 72 (B photoelectric conversion element 72) for detecting blue light and accumulating corresponding signal charge.

The depth of the PN junction of the N-type semiconductor layer 69 and the P-type semiconductor substrate 70 from the surface of the P-type semiconductor substrate 70 is suitable for the absorption of red light. Accordingly, the PN junction of the N-type semiconductor layer 69 and the P-type semiconductor substrate 70 constitutes between the two regions a photodiode 73 (R photoelectric conversion element 73) for detecting red light and accumulating corresponding signal charge.

When a bias potential is applied to the pixel electrode layer 5, the N-type semiconductor layer 67 and the N-type semiconductor layer 69 after the accumulation of signal charge in the photoelectric conversion layer 19, the B photoelectric conversion element 72 and the R photoelectric conversion element 73, potential difference occurs between the two ends of the photoelectric conversion layer 19, the two ends of the B photoelectric conversion element 72 and the two ends of the R photoelectric conversion element 73. The potential difference is then read out by the signal reading circuit 60. Color signals according to the signal charge accumulated in the photoelectric conversion layer 19, the B photoelectric conversion element 72 and the R photoelectric conversion element 73 are then outputted from the solid-state imaging element 200.

In the case where the solid-state imaging element 200 is used instead of the solid-state imaging element 100 in the digital camera shown in FIG. 7, all red signal, blue signal and green signal can be obtained from the same position on the solid-state imaging element 200 corresponding to the various sample points. Accordingly, a color image data can be generated in the same manner as that of three-plate color CMOS type image sensor. The red signal and blue signal can be subjected to the aforementioned signal processing (addition of color signal on the sample point and color signal having the same color as that of the sample point disposed adjacent thereto at a predetermined ratio) or signal mixing (mixing signal charge accumulated in the photoelectric conversion element corresponding to one-pixel data and signal charge accumulated in the photoelectric conversion element aligned adjacent thereto for detecting the same color) to raise sensitivity or S/N ratio and hence a high quality color image data.

Further, in accordance with the solid-state imaging element 200, red signal, blue signal and green signal can be obtained from the same position, making it possible to eliminate the necessity of synchronization and simplify the process of generating a color image data.

For the details of color image sensor comprising a plurality of photoelectric conversion elements laminated in the depth direction of semiconductor substrate 70, reference can be made to JP-T-2002-513145.

In the solid-state imaging element 200, a microlens for converging light rays onto the light receiving region in the R photoelectric conversion element 72 and the B photoelectric conversion element 73 is preferably provided above the counter electrode layer 20 or interposed between the semiconductor substrate 70 and the pixel electrode layer 5 as in the solid-state imaging element 100.

While the solid-state imaging element 200 has been described with reference to the case where the semiconductor substrate has two photoelectric conversion elements, i.e., photoelectric conversion element for detecting red color and photoelectric conversion element for detecting blue color provided thereon, the invention is not limited thereto. Two or more photoelectric conversion elements may be provided on the semiconductor substrate.

While the present embodiment has been described with reference to the case where the photoelectric conversion layer provided in the upper portion of the solid-state imaging element is adapted to detect green color and the photoelectric conversion element provided in the lower portion of the solid-state imaging element is a photoelectric conversion element for detecting red color and blue color, the invention is not limited thereto. In order to realize the invention, it is merely necessary that the color to be detected by the photoelectric conversion layer provided in the upper portion and the color to be detected by the photoelectric conversion element provided in the lower portion be different from each other. For example, the arrangement may be made such that a photoelectric conversion layer for detecting red color is provided in the upper portion while a photoelectric conversion element for detecting blue color and green color is provided in the lower portion. Alternatively, the arrangement may be made such that a photoelectric conversion element for detecting blue color is provided in the upper portion while a photoelectric conversion element for detecting red color and green color is provided in the lower portion. Green color has a higher visibility by the human eye than other colors. Therefore, when the photoelectric conversion layer provided in the upper portion, which can be provided with the greatest light receiving area, is adapted to detect green color, a color image data close to that perceived by the human eye can be generated.

### Embodiment 1-2

As shown in FIG. 1, as green signals there are outputted those corresponding to the total number of pixel data in color image data. However, in the case of a solid-state imaging element which doesn't output as red signals and blue signals those corresponding to the total number of pixel data in color image data, red signals and blue signals are interpolated, making it likely that false colors can be generated. The present embodiment will be described hereinafter with reference to signal processing capable of inhibiting the generation of these false colors. This signal processing is executed in the digital signal processing portion 36 or analog signal processing 32 shown in FIG. 7.

The signal processing will be described hereinafter with reference to color signal obtained from three rows and three lines, totaling 9, of photoelectric conversion elements mainly composed of a photoelectric conversion element 2 or 4 corresponding to one-pixel data in color image data and color signal obtained from three rows and three lines, totaling 9, of signal charge accumulating portions 3 mainly composed of a signal charge accumulating portion 3 corresponding to one-pixel data in color image data.

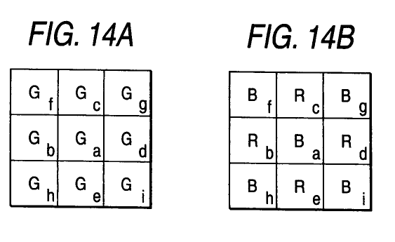

FIG. 14 is a diagram illustrating color signals mapped on the internal memory 40. FIG. 14A is a diagram illustrating the mapping of color signals (represented by “G” in the drawing) obtained from 9 signal charge accumulating portions 3 mainly composed of a signal charge accumulating portion 3 corresponding to one-pixel data in color image. FIG. 14B is a diagram illustrating the mapping of color signals (red signal and blue signal are represented by “R” and “B”, respectively, in the drawing) obtained from 9 photoelectric conversion elements mainly composed of photoelectric conversion element 4 corresponding to one-pixel data in color image data.

In FIG. 14, the sample points for various color signals are given reference numerals a to i, respectively. In FIG. 14, the sample point a is an origin (m, n) and the coefficient assigned to the coordinates (m, n) is k (m, n). The green signal on the sample point (m, n) is g (m, n), the red signal on the sample point (m, n) is r (m, n), and the blue signal on the sample point (m, n) is b (m, n).

The signal processing by which color image data is generated at the various sample points will be described hereinafter.

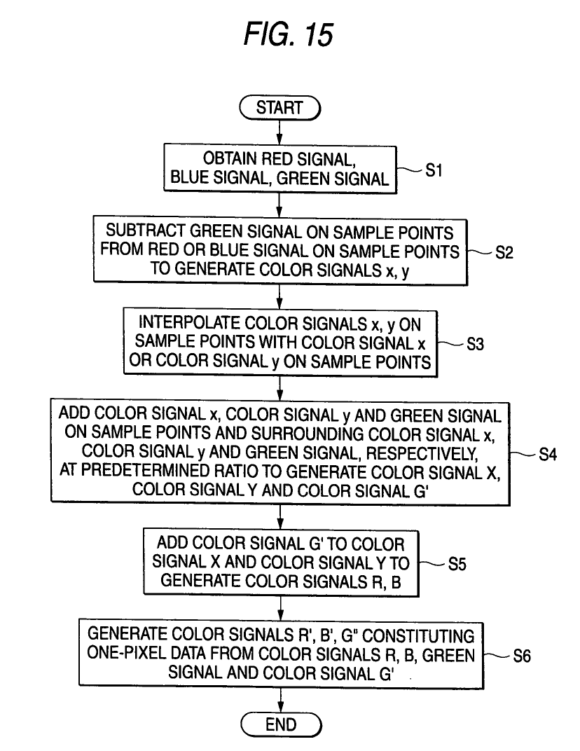

FIG. 15 is a flow chart illustrating a signal processing performed by the digital signal processing portion of the digital camera according to the present embodiment.

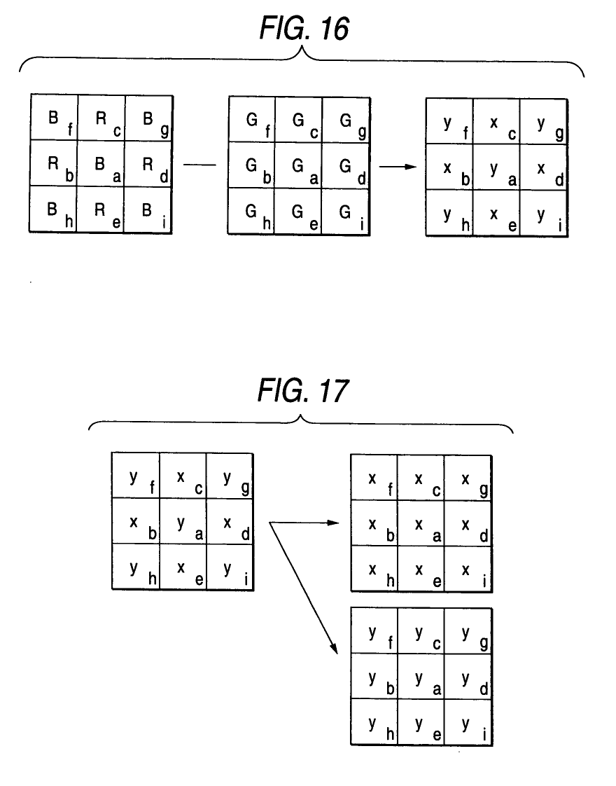

The digital signal processing portion 36 obtains a green signal (first color signal), a red signal (second color signal) and a blue signal (third color signal) from the solid-state imaging element 100 (Step S1) and subtracts from red or blue signals on the sample points a to i green signals on the same sample points to generate a color signal x (fourth color signal) which is a difference between red signal and green signal and a color signal y (fifth color signal) which is a difference between blue signal and green signal on the various sample points (see Step S2 in FIG. 16). Supposing that the color signal x in the coordinates (m, n) is x (m, n) and the color signal y in the coordinates (m, n) is y (m, n), x (m, n) and y (m, n) are determined by the following formulae (1) and (2).
x(m,n)=r(m,n)−g(m,n) (1)
y(m,n)=b(m,n)−g(m,n) (2)

Subsequently, the digital signal processing portion 36 performs signal interpolation with color signal x or color signal y such that two color signals x and y are present on the various sample points (see S3 in FIG. 17). For example, the digital signal processing portion 36 interpolates in a sample point having color signal y present thereon but free of color signal x a color signal x present in the surroundings of the sample point or interpolates in a sample point having color signal x present thereon but free of color signal y a color signal y present in the surroundings of the sample point. The signal interpolation can be carried out by various methods and thus will not be described herein.

Subsequently, the digital signal processing portion 36 adds the green signal, color signal x or color signal y present on the various sample points and the green signal, color signal x or color signal y present on the sample points surrounding the former sample points at a predetermined ratio to generate a color signal X which is a blurred color signal x (sixth color signal), a color signal Y which is a blurred color signal y (seventh color signal) and a color signal G′ which is a blurred green signal on these sample points (S4).

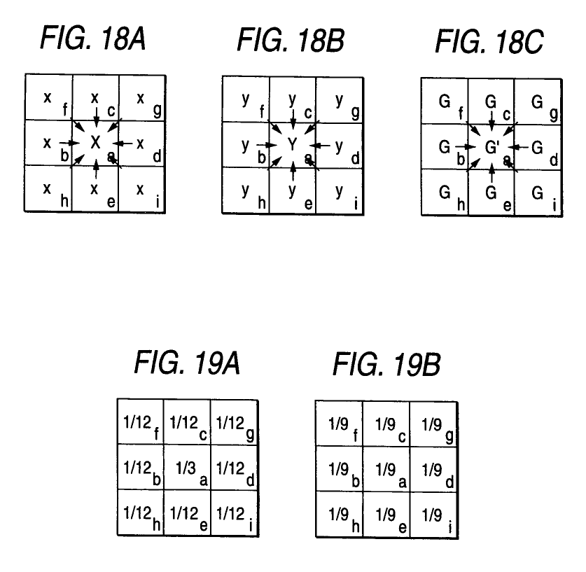

The digital signal processing portion 36 multiplies the color signal x on the sample a and color signals x on the sample points b to i surrounding the sample point a by a predetermined coefficient and then integrates the products of multiplication of the color signals x by the coefficient to generate a signal as a color signal X on the sample point a (see FIG. 18A).

The digital signal processing portion 36 also multiplies the color signal y on the sample a and color signals y on the sample points b to i surrounding the sample point a by a predetermined coefficient and then integrates the products of multiplication of the color signals y by the coefficient to generate a signal as a color signal Y on the sample point a (see FIG. 18B).

The digital signal processing portion 36 also multiplies the green signal on the sample a and green signals on the sample points b to i surrounding the sample point a by a predetermined coefficient and then integrates the products of multiplication of the green signals by the coefficient to generate a signal as a signal G′ on the sample point a (see FIG. 18C).

As the coefficient to be predetermined on the various sample points there are used ones which are weighted on the sample point a as shown in FIG. 19A or ones which are averaged over the various sample points as shown in FIG. 19B.

The color signal X (m, n), the color signal Y (m, n) and the color signal G′ (m, n) on the sample point in the coordinates (m, n) are determined by the following formulae (3), (4) and (5).
G′(m,n)=k(m−1,n+1)*g(m−1,n+1)+k(m,n+1)*g(m,n+1)+k(m+1,n+1)*g(m+1,n+1)+k(m−1,n)*g(m−1,n)+k(m,n)*g(m,n)+k(m+1,n)*g(m+1,n)+k(m−1,n−1)*g(m−1,n−1)+k(m,n−1)*g(m,n−1)+k(m+1,n−1)*g(m+1,n−1) (3)
X(m,n)=k(m−1,n+1)*x(m−1,n+1)+k(m,n+1)*x(m,n+1)+k(m+1,n+1)*x(m+1,n+1)+k(m−1,n)*x(m−1,n)+k(m,n)*x(m,n)+k(m+1,n)*x(m+1,n)+k(m−1,n−1)*x(m−1,n−1)+k(m,n−1)*x(m,n−1)+k(m+1,n−1)*x(m+1,n−1) (4)
Y(m,n)=k(m−1,n+1)*y(m−1,n+1)+k(m,n+1)*y(m,n+1)+k(m+1,n+1)*y(m+1,n+1)+k(m−1,n)*y(m−1,n)+k(m,n)*y(m,n)+k(m+1,n)*y(m+1,n)+k(m−1,n−1)*y(m−1,n−1)+k(m,n−1)*y(m,n−1)+k(m+1,n−1)*y(m+1,n−1) (5)

Since the color signal x is originally a signal obtained by subtracting green signal from red signal, a blurred red color signal R can be obtained by adding the color signal G′ to blurred color signal X. Similarly, since the color signal y is a signal obtained by subtracting green signal from blue signal, a blurred blue color signal B can be obtained by adding the color signal G′ to blurred color signal Y. The digital signal processing portion 36 determines blurred color signal R and color signal B using the following formulae (6) and (7) (Step S5).
R(m,n)=X(m,n)+G′(m,n) (6)
B(m,n)=Y(m,n)+G′(m,n) (7)
wherein R (m, n) is blurred color signal R on the sample point in the coordinates (m, n); and B (m, n) is blurred color signal B on the sample point in the coordinates (m, n).

Finally, the digital signal processing portion 36 determines from the blurred color signal R and blurred color signal B a red color signal R′ constituting one-pixel data and a blue color signal B′ constituting one-pixel data using the following formulae (8) and (9) and a green color signal G″ constituting one-pixel data using the following formula (10) (Step S6).
R′(m,n)=R(m,n)+{g(m,n)−G′(m,n)}=X(m,n)+g(m,n) (8)
B′(m,n)=B(m,n)+{g(m,n)−G′(m,n)}=Y(m,n)+g(m,n) (9)
G″(m,n)=G′(m,n)+{g(m,n)−G′(m,n)}=g(m,n) (10)
wherein R′ (m, n) is color signal R′ generated on the sample point in the coordinates (m, n); B′ (m, n) is color signal B′ generated on the sample point in the coordinates (m, n); and G″ (m, n) is color signal G″ generated on the sample point in the coordinates (m, n).

The digital signal processing portion 36 performs the aforementioned signal processing to generate red signal R′, blue signal B′ and green signal G″ on the various sample points.

As mentioned above, in accordance with the signal processing of the present embodiment, green signals present on all the sample points are used to generate color signal R′ and color signal B′ constituting one-pixel data, making it possible to make false colors less remarkable than in the case where only red signal or blue signal on the various sample points are used to generate color signal R′ and color signal B′.

While the foregoing description has been made with reference to the case where color signals R and B are once generated in S5 of FIG. 15, the color signals R and B may not be generated. Instead, color signals R′ and B′ may be generated by adding green signal and green signal directly to color signals X and Y, respectively, after S4.

The foregoing description has been made with reference to the case where color signals X, Y and G′ are generated on the various sample points at S4 of FIG. 15. However, with respect to the sample points having color signal x after S2 process (equivalent to sample points having red signal), color signal present on these sample points can be treated as color signal R′ as it is. Therefore, these sample points don't need to be subjected to processing which comprises adding green signal to color signal X thus generated to generate color signal R′.

Similarly, with respect to the sample points having color signal y after S2 process (equivalent to sample points having blue signal), color signal present on these sample points can be treated as color signal B′ as it is. Therefore, these sample points don't need to be subjected to processing which comprises adding green signal to color signal Y thus generated to generate color signal B′.

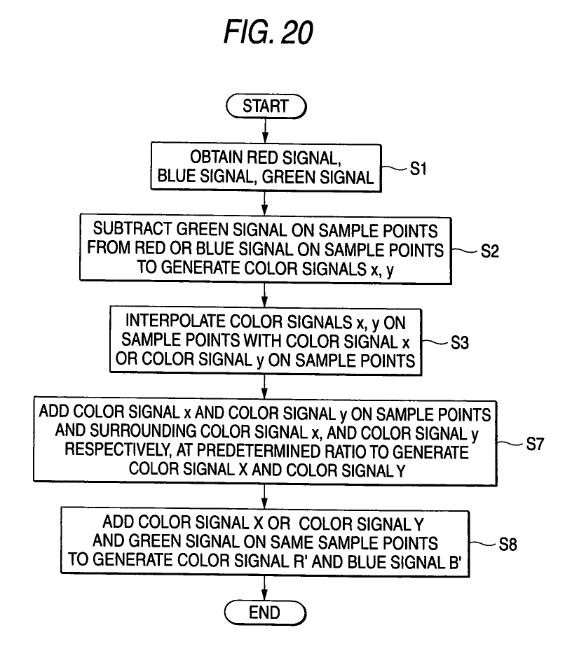

As can be seen in the formulae (8) to (10), the red signal R′ constituting one-pixel data can be determined by adding the color signal X and the green signal present on the same sample point. The blue signal B′ constituting one-pixel data can be determined by adding the color signal Y and the green signal present on the same sample point. The green signal G″ constituting one-pixel data is a green signal itself Therefore, the flow in FIG. 15 can be simplified as shown in FIG. 20.

FIG. 20 is a modification of a flow chart illustrating a signal processing performed by the digital signal processing portion of the digital camera according to the present embodiment. In FIG. 20, where the steps function in the same way as in FIG. 15, the same reference numerals are used.

After the interpolation of color signals x and y in the sample points at S3, the digital signal processing portion 36 then adds the color signal x or color signal y present on the various sample points and the color signal x or color signal y present on the sample points surrounding these sample points at a predetermined ratio to generate a color signal X which is a blurred color signal x (sixth color signal) and a color signal Y which is a blurred color signal y (seventh color signal) on these sample points (S7).

Subsequently, the digital signal processing portion 36 adds the color signal X and green signal present on the same sample point to generate a red signal R′ constituting one-pixel data on the various sample points and adds the color signal Y and green signal present on the same sample point to generate a blue signal B′ constituting one-pixel data on the various sample points (S8). The green signal present on the various sample points obtained at S1 is a green signal G″ constituting one-pixel data. Accordingly, the aforementioned processing makes it possible to provide the various sample points with three signals, i.e., red signal R′, blue signal B′ and green signal.

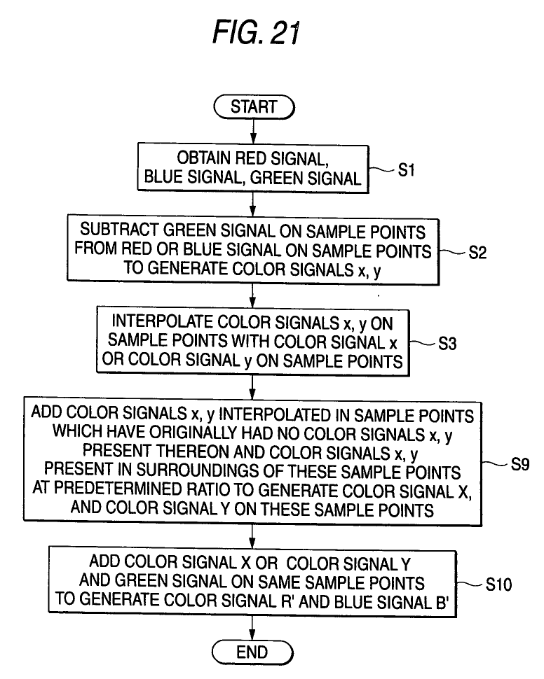

In the flow shown in FIG. 20, the color signal X and color signal Y are generated on the various sample points at S4. However, referring to the sample points having a color signal x present thereon after S2 processing (equivalent to the sample points having a red signal present thereon), the red signal present on these sample points can be treated as they are as red signal R′. Therefore, these sample points may not be subjected to processing which comprises generating a color signal X, and then adding a green signal to the color signal X thus generated to generate a red signal R′. Similarly on the sample points having a color signal y present thereon after S2 processing (equivalent to the sample points having a blue signal present thereon), the blue signal present on these sample points can be treated as they are as blue signal B′. Therefore, these sample points may not be subjected to processing which comprises generating a color signal Y, and then adding a green signal to the color signal Y thus generated to generate a blue signal B′. The flow of this processing will be described hereinafter in connection with FIG. 21.

FIG. 21 is a modification of a flow chart illustrating a signal processing performed by the digital signal processing portion of the digital camera according to the present embodiment. In FIG. 21, where the steps function in the same way as in FIG. 20, the same reference numerals are used.

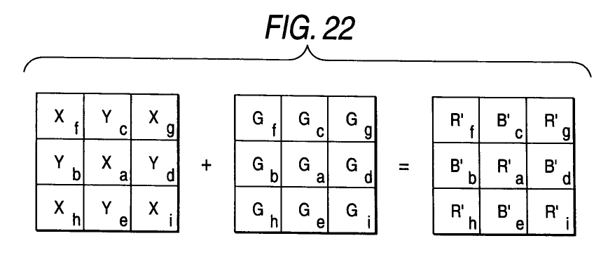

After the interpolation of color signals x and y in the sample points at S3, the digital signal processing portion 36 then adds the color signal x interpolated in the sample points which have originally had no color signal x present thereon and the color signal x present on the sample points surrounding these sample points at a predetermined ratio to generate a color signal X on these sample points and adds the color signal y interpolated in the sample points which have originally had no color signal y present thereon and the color signal y present on the sample points surrounding these sample points at a predetermined ratio to generate a color signal Y on these sample points (S9, see the left most part of FIG. 22).

Subsequently, the digital signal processing portion 36 adds the color signal X and green signal present on the same sample point to generate a red signal R′ constituting one-pixel data and adds the color signal Y and green signal present on the same sample point to generate a blue signal B′ constituting one-pixel data (S10, see the rightmost part of FIG. 22). Referring to the sample points which have not generated red signal R′ and red signal B′, the red signal and blue signal obtained at S1 can be treated as they are as red signal R′ and blue signal B′, respectively. Accordingly, the various sample points can be provided with three signals, i.e., red signal R′, blue signal B′ and green signal.

In the signal processing according to the present embodiment, the processing at S1 in FIGS. 15, 20 and 21 each are preferably preceded by the signal processing described in the embodiment 1-1 (the red signal or blue signal present on the various sample points and the red signal or blue signal present on the sample points surrounding these sample points (e.g., sample points adjacent to these sample points) are added at a predetermined ratio to generate a new red signal or blue signal). Using the red signal and blue signal obtained by this signal processing, the processing following S1 in FIGS. 15, 20 and 21 may be effected. In this manner, a color image data having little remarkable false colors and an enhanced sensitivity or S/N ratio can be generated.

The signal processing described in the present embodiment is not limited to an imaging device having a single-plate solid-state imaging element as shown in FIG. 1 mounted thereon. The signal processing described in the present embodiment can be applied also to an imaging device which comprises two solid-state imaging elements, i.e., a solid-state imaging element that outputs only a green signal in a number equal to the maximum number of pixel data in color image data and a solid-state imaging element that outputs only a red signal and a blue signal in a number equal to the maximum number of pixel data in color image data to generate a color image data.

While the present embodiment has been described with reference to the case where the photoelectric conversion layer provided in the upper portion of the solid-state imaging element is adapted to detect green color and the photoelectric conversion element provided in the lower portion of the solid-state imaging element is a photoelectric conversion element for detecting red color and blue color, the invention is not limited thereto. In order to realize the invention, it is merely necessary that the color to be detected by the photoelectric conversion layer provided in the upper portion and the color to be detected by the photoelectric conversion element provided in the lower portion be different from each other. For example, the arrangement may be made such that a photoelectric conversion layer for detecting red color is provided in the upper portion while a photoelectric conversion element for detecting blue color and green color is provided in the lower portion. Alternatively, the arrangement may be made such that a photoelectric conversion element for detecting blue color is provided in the upper portion while a photoelectric conversion element for detecting red color and green color is provided in the lower portion. Green color has a higher visibility by the human eye than other colors. Therefore, when the photoelectric conversion layer provided in the upper portion, which can be provided with the greatest light receiving area, is adapted to detect green color, a color image data close to that perceived by the human eye can be generated.

### Embodiment 2

Preferred embodiments of implementation of the imaging device, signal processing method on solid-state imaging element according to the invention and digital camera and its controlling method will be described in connection with the attached drawings.

### Embodiment 2-1

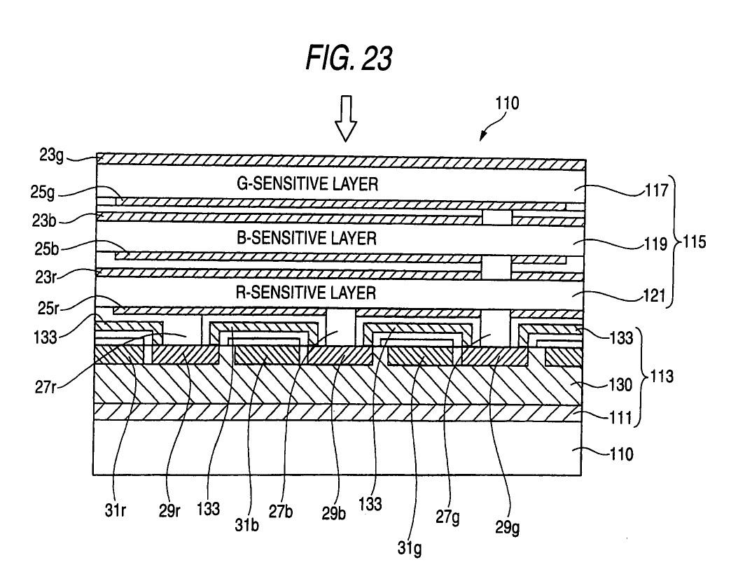

FIG. 23 is diagrammatic sectional view of a one-pixel portion in a multi-layer solid-state imaging element according to an embodiment of implementation of the invention. In the present embodiment, three photoelectric conversion layers are laminated so that electric signals corresponding to three primaries, i.e., red color (R), green color (G) and blue color (B) are provided. In other words, a color image is taken. However, photoelectric conversion layers corresponding to other colors (e.g., emerald GB, which is an intermediate color) may be added to enhance the color reproducibility.

In FIG. 23, a P-well layer 110 formed on an n-type silicon substrate 110 has a transmission channel layer 113 formed as an underlying layer on the surface side thereof. Above the transmission channel layer 113 is formed a three-layer photoelectric conversion portion 115 as an upper layer.

The photoelectric conversion portion 115 is composed of a G photoelectric conversion layer 117 (hereinafter referred to as “G-sensitive layer”) for absorbing G light to generate G signal charge, a B photoelectric conversion layer 119 (hereinafter referred to as “B-sensitive layer”) for absorbing B light to generate G signal charge and an R photoelectric conversion layer 121 (hereinafter referred to as “R-sensitive layer”) for absorbing R light to generate R signal charge. The light-sensitive layers 117, 119 and 121 are disposed interposed between transparent electrodes 23g, 23b and 23r and transparent counter electrodes 25g, 25b and 25r, respectively.

The G-sensitive layer 117 transmits R (red) light and B (blue) light, the B-sensitive layer 119 transmits G light and R light, and the R-sensitive layer 121 transmits B light and G light. In this arrangement, the amount of light that reaches the underlying light-sensitive layers doesn't drop due to the light-sensitive layers themselves even if the light-sensitive layers 117, 119 and 121 are laminated.

The transparent counter electrodes 25g, 25b and 25r each are disposed independently every pixel and are connected to signal charge accumulating diodes 29g, 29b and 29r for each pixel via contact electrodes 27g, 27b and 27r, respectively.

On the surface portion of the P-well layer 111 formed on the n-type silicon substrate 110 are formed a signal charge accumulating diode 29r for accumulating red signal, a vertical transmission channel 31r for reading red signal, a signal charge accumulating diode 29g for accumulating green signal, a vertical transmission channel 31g for reading green signal, a signal charge accumulating diode 29b for accumulating blue signal and a vertical transmission channel 31b for reading blue signal.

The signal charges accumulated in the signal charge accumulating diodes 29g, 29b and 29r are read as pixel signals by the vertical transmission channels 31g, 31b and 31r, which each are a CCD transmission circuit for the circuit layer 130, respectively.

Above the vertical transmission channels 31g, 31b and 31r is formed an insulating/light-shielding layer 133 composed of insulating layer and light-shielding layer. While the present embodiment has been described with reference to the case where the G-sensitive layer 117 is disposed as an uppermost layer and the B-sensitive layer 119 and the R-sensitive layer 121 are disposed in this order under the G-sensitive layer 117, the R-sensitive layer 121 and the B-sensitive layer 119 may be disposed in this order under the G-sensitive layer 117.

The signals according to the amount of signal charge accumulated in the signal charge accumulating diodes 29g, 29b and 29r for color signal accumulation are each read by the vertical transmission channels 31g, 31b and 31r, and then taken out by reading electrodes (not shown) formed on the semiconductor substrate. This arrangement is the same as in related art CCD image sensor, etc.

While the present embodiment has been described with reference to the case where signals according to the amount of signal charges are read by the CCD transmission circuit formed on the semiconductor substrate, arrangement may be made such that charges accumulated in the signal charge accumulating diodes 29g, 29b and 29r for color signal accumulation are read by allowing an MOS circuit formed on the semiconductor substrate to address the signals according to the amount of signal charges as in related art CMOS image sensor.

The transparent electrodes 23g, 23b and 23r and the transparent counter electrodes 25g, 25b and 25r each are a homogeneous transparent electrode which may be a thin film of tin oxide (SnO₂), titanium oxide (TiO₂), indium oxide (InO₂) or indium oxide-tin (ITO). The formation of such a thin film may be carried out by laser ablation method, sputtering method or the like. However, the electrode material is not limited to these materials.

As the color light-sensitive layers 117, 119 and 121 there may be each used a photoconductive type, p-n junction type, Schottky's junction type, PIN junction type, MSM (metal-semiconductor-metal) type or phototransistor type light-receiving element. Examples of the material constituting the light-receiving element include inorganic semiconductor materials such as Si, a-Si, CdS, ZnS, Se, SeTeAS, ZnSe and GaAs, and arbitrary organic semiconductor materials.

As the organic semiconductor material there is preferably used a material having an absorption peak with respect to incident light. For example, the following compounds are preferably used. Examples of the preferred compounds include acenes such as perylene, tetracene, pentacene and pyrene, derivatives thereof, conjugated polymer compounds such as polyacetylene derivative, polythiophene derivative having thiophene ring, poly(3-alkylthiophene) derivative, poly(3,4-ethylenedioxythiophene) derivative, polychenylene vinylene derivative, polyphenylene derivative having benzene ring, polyphenylene vinylene derivative, polypyridine derivative having nitrogen atom, polypyrrole derivative, polyaniline derivative and polyquinoline derivative, oligomers such as dimethyl sexithiophene and quarterthiophene, organic molecules such as copper phthalocyanine derivative, discotic liquid crystals such as triphenylene derivative, smectic liquid crystals such as benzothiazole derivative, and liquid crystal polymers such as poly(9,9-dialkylfluorene-bithiophene) copolymer. However, the invention is not limited to these compounds.

In a broad sense, the term “organic semiconductor” as used herein is meant to indicate an organic material that can use the movement of carrier (electron, hole). Examples of such an organic material include ordinary dyes and pigments. For example, dye materials such as Rhodamine B, eosine-Y and coumarine may be used. Azo pigments, squarilium pigments, azlenium pigments, phthalocyanine pigments, etc. may be used.

As the material constituting the light-receiving element there may be used a mixture or laminate of these organic semiconductor materials and dye materials. For example, an organic semiconductor material (dye) having controlled receptive spectrum and an organic semiconductor material having an excellent electrical conductivity may be mixed.

The organic compound semiconductor layer to be used in the invention may comprise a proper dopant incorporated therein to adjust its electrical conductivity. Examples of the dopant employable herein include acceptor-like materials such as I₂, Br₂, Cl₂, ICl, BF₃, PF₅, H₂SO₄, FeCl₃ and TCNQ (tetracyanoquino dimethane), donor-like materials such as Li, K, Na and Eu, and surface active agents such as alkylsulfonic acid salt and alkylbenzenesulfonic acid salt.

The configuration of the aforementioned solid-state imaging element 110 is produced by the semiconductor process for the related art CCD type image sensor or CMOS type image sensor.

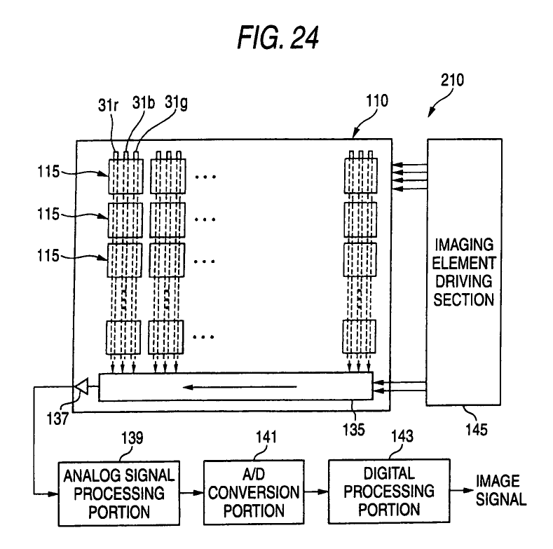

FIG. 24 is a conceptional block diagram of an imaging device 210 comprising the solid-state imaging element 110 thus arranged.

The solid-state imaging element 110 comprises a plurality of the aforementioned photoelectric conversion portions 15 aligned in the horizontal and vertical directions. The signal charge accumulated in the various photoelectric conversion portions according to the amount of incident light are transmitted to the vertical transmission channels 31g, 31b and 31r disposed under the photoelectric conversion portions 115 through which they are then sequentially transmitted to the horizontal transmission channel 135 through which they are then sequentially transmitted to a floating diffusion amplifier 137 from which pixel signals are then outputted. The pixel signals thus outputted are subjected to predetermined analog signal processing in an analog signal processing portion 139, and then converted by an A/D conversion portion 141 to a digital signal which is then transmitted to a digital signal processing portion 143. For the transmission of signal charges through the vertical transmission channels 31g, 31b and 31r and the horizontal transmission channel 135, a drive signal from an imaging element driving portion 145 is used. The alignment pattern of the photoelectric conversion portions 115 may be a square lattice shown or one obtained by rotating the square lattice at an angle of 45°.

A signal processing method on the aforementioned multi-layer solid-state imaging element 100 will be described hereinafter.

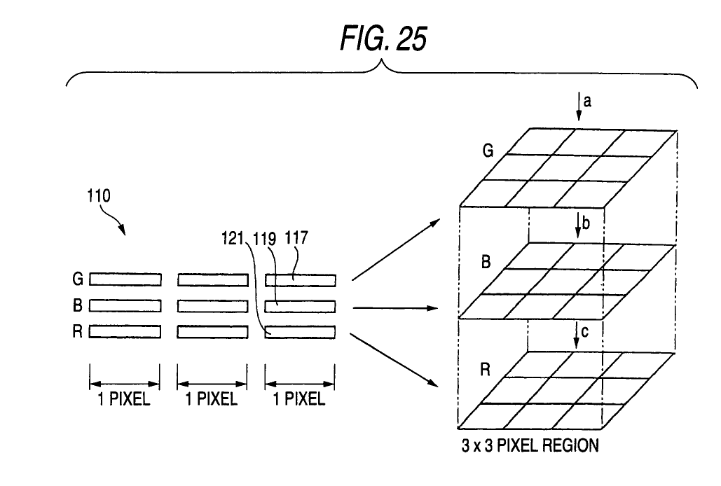

FIG. 25 is a view diagrammatically illustrating the pixels in a solid-state imaging element.

Explaining the 3×3 pixel region every each layer, the solid-state imaging element 110 having a three-layer structure comprising a G-sensitive layer 117, a B-sensitive layer 119 and an R-sensitive layer 121 has the 3×3 pixel regions laminated in the vertical direction.

Accordingly, the G-sensitive layer 117, which is the uppermost layer, can receive directly substantially all the incident light rays a, but the B-sensitive layer 119 is irradiated with light rays b transmitted by the G-sensitive layer 117. The R-sensitive layer 121 is then irradiated with light rays c transmitted by the B-sensitive layer 119. Further, since the contact electrodes 27g, 27b and 27r shield a part of the pixel region from light as shown in FIG. 23, the lower light-sensitive layers receive less amount of light rays and lower sensitivity. In general, in order to enhance sensitivity by signal processing, gain may be raised. However, this also causes the amplification of noise components, resulting in the drop of S/N ratio.

Then, the invention makes the use of a phenomenon that the visual resolution of human being is high with respect to the wavelength range of G light but is low with respect to the wavelength range of B light and R light to generate a pixel signal every one pixel unit with respect to G light as in ordinary method. With respect to B light and R light, signal charges from a plurality of pixels in B-sensitive layer 119 and R-sensitive layer 121 are added to generate a pixel signal having an enhanced S/N ratio.

In this method, with respect to B pixels and R pixels, the resulting images are blurred. However, since the visual resolution of human being is originally low with respect to R and B, there occurs little or no substantial deterioration of image quality even when B pixels and R pixels are each added to each other. In other words, good optical detection is allowed without deteriorating visual color resolution or S/N ratio.

General examples of the method for adding signal charges in a plurality of pixels in various light-sensitive layers include charge mixing involving the mixing charges accumulated in the various pixels in the light-sensitive layers and pixel addition involving the addition of pixels generated on the basis of signal charges in the various pixels in the light-sensitive layers. Both the methods allow addition of signal charges of the invention. Taking the pixel addition by way of example, a method involving digitization of pixel signals followed by addition will be described.

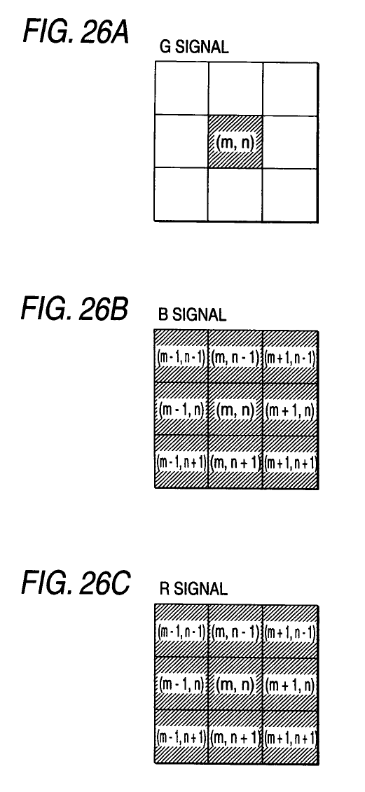

FIG. 26 is a diagram illustrating a specific example of pixel addition for 3×3 pixel alignment wherein FIG. 26A depicts G pixels, FIG. 26B depicts B pixels and FIG. 26C depicts R pixels.

The following processing is conducted in the digital signal processing portion 143 in FIG. 24.

Supposing that the horizontal position is represented by m and the vertical position is represented by n, the procedure of pixel addition with respect to pixel (m, n) will be described below. G signals are processed without pixel addition. B signals and R signals are processed such that 8 adjacent pixels are added to the central pixel.

Supposing that the G signal thus processed is represented by G (m, n), B signal thus processed is represented by B (m, n) and R signal thus processed is represented by R (m, n), the contents of the processing will be described in detail in the following formulae (1) to (3).
G(m,n)signal=g(m,n) (1)
B(m,n)signal=k(−1,1)×b(m−1,n−1)+k(0,1)×b(m,n−1)+k(1,1)×b(m+,n−1)+k(−1,0)×b(m−1,n)+k(0,0)×b(m,n)+k(1,0)×b(m+1,n)+k(−1,−1)×b(m−1,n+1)+k(0,−1)×b(m,n+1)+k(1,−1)×b(m+1,n+1) (2)
R(m,n)signal=k(−1,1)×r(m−1,n−1)+k(0,1)×r(m,n−1)+k(1,1)×r(m+1,n−1)+k(−1,0)×r(m−1,n)+k(0,0)×r(m,n)+k(1,0)×r(m+1,n)+k(−1,−1)×r(m−1,n+1)+k(0,−1)×r(m,n+1)+k(1−,−1)×r(m+1,n+1) (3)
wherein:

g (m, n): G signal before pixel addition

b (m, n): B signal before pixel addition

r (m, n): R signal before pixel addition

k: Weighting coefficient

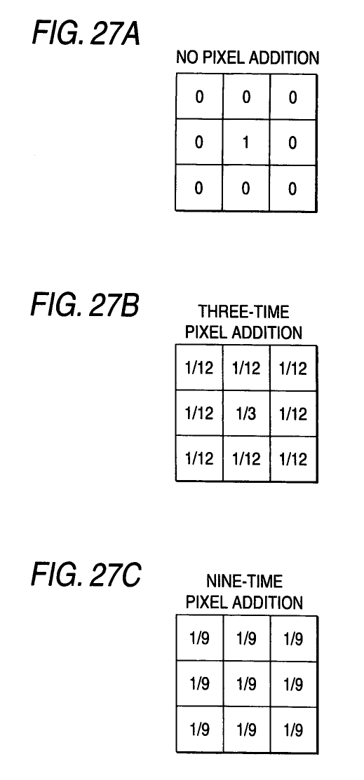

The weighting coefficient k is a 3×3 mask pattern in the present embodiment. An example of 3×3 mask pattern is shown in FIG. 27. FIG. 27A is a diagram illustrating a mask pattern involving no pixel addition, FIG. 27B is a mask pattern involving three time pixel addition and FIG. 27C is a mask pattern involving nine time pixel addition. In the mask pattern of FIG. 27A, only the weighting coefficient k (0, 0) in the center of the mask is 1 and the other weighting coefficients are all 0. In the case where this mask pattern is applied to the aforementioned formulae (1) to (3), only G, B and R color signals corresponding to the central pixel (m, n) are effective. As a result, no addition of central pixel and its surrounding pixels is effected.

In the mask pattern of FIG. 27B, the weighting coefficient k (0, 0) in the center of the mask is ⅓ and the other weighting coefficients are all 1/12. In this case, the central pixel (m, n) and the surrounding pixels are added with the central pixel (m, n) weighted more than the other. In this manner, pixel signals are averaged between the central pixel and the surrounding pixels adjacent thereto to enhance S/N ratio.

In the mask pattern of FIG. 27C, all the weighting coefficients are each 1/9. In this arrangement, the degree of averaging between the central pixel and the surrounding pixels is further enhanced from the mask pattern of FIG. 27B to further enhance S/N ratio.

Supposing that all the weighting coefficients k (−1,1) to k (1,−1) are 1, B (m, n) signal and R (m, n) are nine times b (m, n) signal and r (m, n) signal which are not yet processed for pixel addition. However, B (m, n) signal and R (m, n) signal extend to one surrounding pixel to cause blurring. On the other hand, when the various coefficients k (−1,1) to (1,−1) each are weighted with the weighting coefficient k (0, 0) as maximum, the degree of blurring is reduced and the sensitivity rise is reduced. Therefore, the value of weighting coefficient k is properly predetermined so as to obtain optimum conditions according to the picture-taking purpose of the imaging device 200.

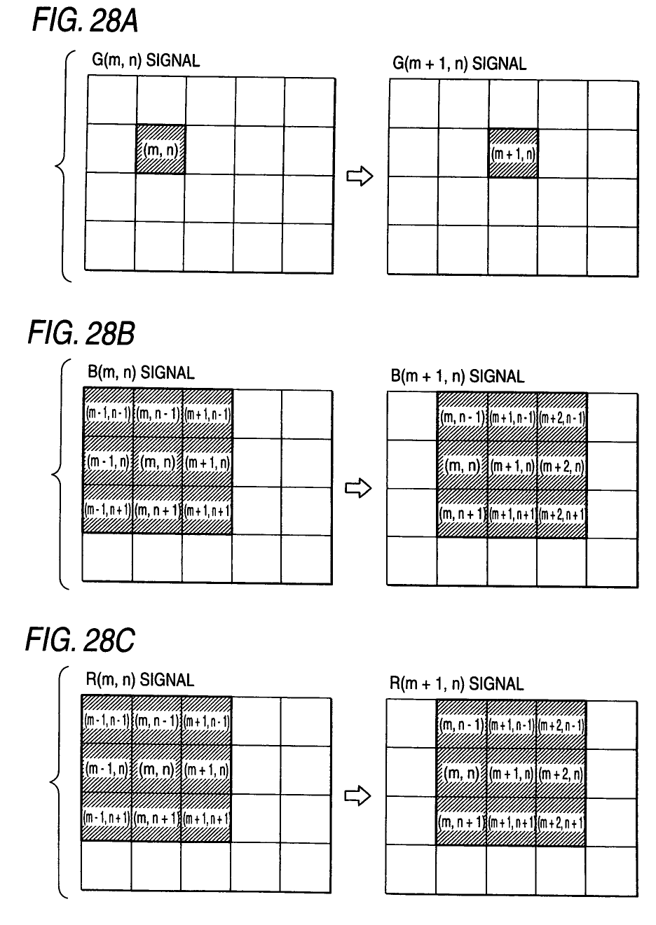

FIG. 28 is a diagram illustrating how the points to be processed for pixel addition are moved wherein FIG. 28A depicts G signal, FIG. 28B depicts B signal and FIG. 28C depicts R signal.

Supposing that G signal corresponding to pixel (m, n) shown in the left portion of FIG. 28A is represented by G (m, n), B (m, n) signal and R (m, n) signal are signals obtained by adding corresponding pixels (m, n) corresponding to G pixel (m, n) and R pixel (m, n) and surrounding pixels adjacent to the corresponding pixel (m, n) as shown in FIGS. 28B and 28C, respectively. When the pixel (m, n) to be processed is moved to neighbor in the horizontal direction (right portion in FIG. 28) to determine pixel signal corresponding to pixel (m+1, n), the result is G (m+1, n) signal shown in FIG. 28A with respect to G signal. With respect to B signal and R signal, signals are obtained by adding corresponding pixels (m+1, n) and surrounding pixels adjacent to the corresponding pixel (m+1, n) as shown in the right portion of FIGS. 28B and 28C. By thus moving the points to be processed in the horizontal direction and vertical direction, the entire picture is subjected to pixel addition.

The more the number of pixels to be added is, the more is enhanced S/N ratio of color signal, but the lower is the color resolution. In other words, the number of adjacent pixels to be added is trade-off of S/N ratio of color signal with color resolution. As the mask pattern, 3×3 pixel alignment is exemplified. However, the mask pattern is not limited to 3×3 pixel alignment. The mask pattern may have a larger size. In the present configuration, the digital processing portion 43 acts as a weighting unit to store optimum weighting coefficient.

As described above, in accordance with the imaging device 210 of the present embodiment, three light-sensitive layers G, B and R are laminated to form one (one pixel) photoelectric conversion portion. Accordingly, the lower light-sensitive layers receive less amount of light rays and lower sensitivity and S/N ratio. With signal charge in one pixel in the upper light-sensitive layer, a pixel signal corresponding to the one pixel is generated according to the results of processing of various signal charges in the corresponding pixel in the underlying light-sensitive layers at the position corresponding to the one pixel and the surrounding pixels adjacent thereto, i.e., value obtained by substantially adding the various signal charges and a value according to signal charge in the one pixel in the upper layer. In this manner, S/N ratio of pixel signal corresponding to the underlying light-sensitive layers (B, R) can be raised, making it possible to form a high quality image. Further, even when signal charges are added at a plurality of pixels in the underlying light-sensitive layers, the deterioration of resolution is not visually remarkable, making it possible to prevent the image from being substantially perceived blurred. Moreover, pixel addition is carried out by digital signal processing, making it easy to optimize the imaging performance according to the purpose without changing the structure of the solid-state imaging element.

While the present embodiment has been described with reference to the case where as a solid-state imaging element there is exemplified CCD image sensor, the invention is not limited thereto. CMOS image sensor may be used.

Even such a CMOS image sensor can perform the same processing as the aforementioned CCD image sensor and provide the same effect as the CCD image sensor.

### Embodiment 2-2

An embodiment 2-2 of implementation of the imaging device according to the invention will be described hereinafter.

The addition of signal charges in various pixels in the present embodiment is effected in the analog signal processing portion 39 in FIG. 24.

In the present embodiment, B signal and R signal among analog signals outputted from the floating diffusion amplifier 37 are amplified (or damped) according to signal charge to perform pixel addition corresponding to addition of predetermined pixels to each other. Instead of signal amplification, outputted analog signal may be passed through a low pass filter LPF to perform averaging. In this manner, the configuration of the analog circuit can be further simplified.

In accordance with the addition of signal charges in pixels by the aforementioned analog circuit, high speed processing is allowed as compared with the addition by digital circuit, making it possible to simplify the device configuration.

### Embodiment 2-3

An embodiment 2-3 of implementation of the imaging device according to the invention will be described hereinafter.

The addition of signal charges in pixels according to the present embodiment is charge mixing involving the mixing of signal charges accumulated in the various pixels in the photoelectric conversion layers.

In the present embodiment, CCD image sensor is used. As a method of mixing charges there may be used a method involving the mixing of pixel signals to be added in the charge transmission lines (vertical transmission channels 31g, 31b, 31r, horizontal transmission channel 135) during the reading of charges in the solid-state imaging element 110). In some cases, the horizontal transmission channel 135 may be provided with a charge accumulating portion in which charges are mixed. In other words, the charge reading method may be of any process type such as line address, frame transfer, interline transfer and frame interline transfer.

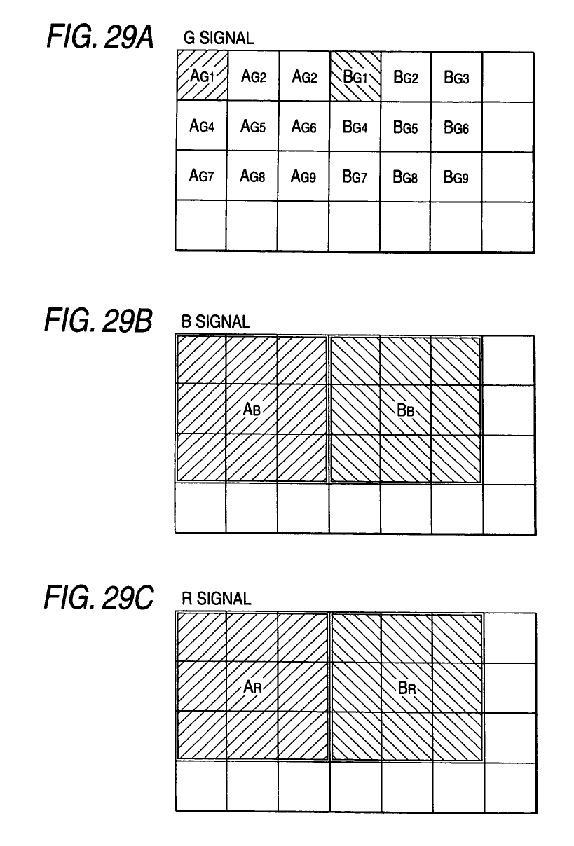

FIG. 29 is a diagram illustrating the procedure of generating pixel signals in the case of charge mixing. FIG. 29A depicts G signal in the various pixels. FIGS. 29B and 29C depict B signal and R signal, respectively. Taking into account the case where the same processing as addition of 3×3 pixels as shown in FIG. 26 is effected by charge mixing, with respect to pixel signal at the position represented by A_{G1} among the various pixels shown in G signal there is used A_{G1} as G signal, A_{B} obtained by charge-mixing 3×3 pixels including the position represented by A_{G1} as B signal and A_{R} obtained by charge-mixing 3×3 pixels including the position represented by A_{G1} as R signal. With respect to B signal and R signal, as the corresponding pixels of B signal corresponding to A_{G1} to A_{G9} of G signal there are all used A_{B} and as the corresponding pixels of R signal there are all used A_{R}. In other words, as B signal and R signal corresponding to pixels of A_{G1} to A_{G9} there are uniformly used values A_{B} and A_{R} obtained by pixel mixing.

With respect to B_{G1} which is a pixel adjacent to A_{G3} among G signals, as G signal there is used B_{G1}. With respect to B signal, as pixels corresponding to B_{G1} to B_{G9} pixels of G signal there are all used B_{B}. As pixels corresponding to R signal there are all used B_{R}.

As mentioned above, with respect to G signal, various image signals are generated every pixel. With respect to B signal and R signal, charge mixing is effected on pixels in 3×3 block. The results are used in common to pixels in the block to generate a pixel signal.

In accordance with the imaging device according to the present embodiment, charge mixing is effected instead of pixel mixing, making it possible to generate a pixel signal at a high speed without performing calculation after reading of signal charges from the various pixels. The pixels to be processed for charge mixing are not limited to the aforementioned examples. These pixels may be mixed with other pixels.

While the addition of pixel signals or signal charges in a plurality of pixels is effected on both B pixel and R pixel, the invention is not limited thereto. This addition may be effected on only B pixel or R pixel. For example, in the case where sensitivity, color resolution and S/N ratio can be obtained to a sufficient level according to picture-taking conditions, signal processing can be effected more properly by properly selecting whether or not addition should be effected individually on B pixel and R pixel. As a result, it is assured that an image data having good sensitivity, color resolution and S/N ratio can be generated.

### Embodiment 2-4

An embodiment 2-4 of implementation of the imaging device according to the invention using the aforementioned signal processing method on solid-state imaging element will be described hereinafter.

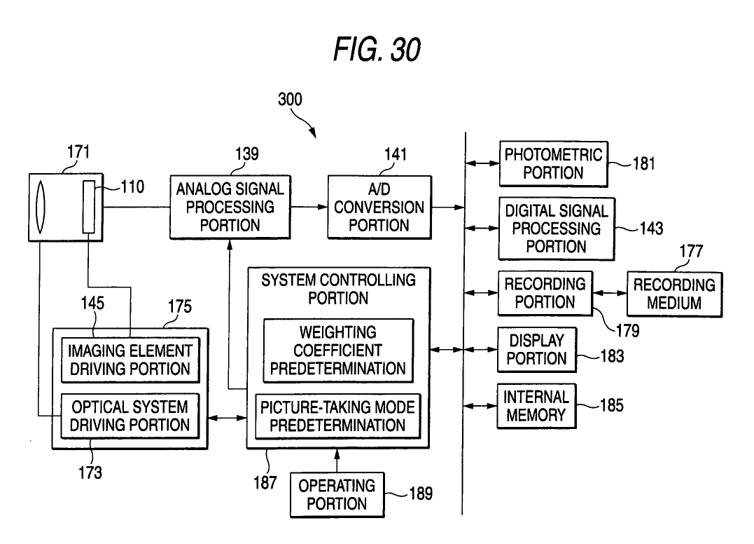

FIG. 30 is a configurational diagram illustrating an example of the imaging device according to the present embodiment.

The imaging device 300 according to the present embodiment is a so-called digital camera which is arranged so as to allow still image picture-taking and animation picture-taking. The configuration of the imaging device 300 will be described hereinafter.

The imaging device 300 comprises a imaging portion 171 having a solid-state imaging element 110 and an optical system such as lens and stop mounted therein, an analog signal processing portion 139, an A/D conversion portion 141, a driving portion 175 having a imaging element driving portion 145 and an optical system driving portion 173, a digital signal processing portion 143, a recording portion 179 having a detachable recording medium 177, a photometric portion 181 as a photometric unit which performs photometry by extracting and integrating brightness data of picture taken, a display portion 183, an internal memory 185, a system controlling portion 187 for controlling the various portions, and an operating portion 189 for inputting necessary data into the system controlling portion 187.

The imaging portion 171 comprises an optical system such as picture-taking lens, stop and optical filter (infrared-absorbing filter, optical LPF) and a solid-state imaging element 110 to take a picture of an object. The imaging portion 171 outputs an analog picture signal. The picture signal obtained in the imaging portion 171 is transmitted to the analog signal processing portion 139 in which it is then subjected to predetermined analog signal processing. The picture signal thus processed is transmitted to the A/D conversion portion 141 in which it is then converted to a digital signal as a picture image data which is then transmitted to the digital signal processing portion 143, etc.

During picture-taking, the imaging portion 171 is controlled via the driving portion 175. When triggered by release switch ON made by operation by the shutter release button or the like provided in the operating portion 189, the charge transfer type solid-state imaging element 110 such as CCD image sensor is driven by a drive signal from a timing generator (not shown) incorporated in the driving portion 175 at a predetermined timing.

The driving portion 175 is mainly adapted to output a predetermined drive signal on the basis of control made by the system controlling portion 187. The driving portion 175 comprises an imaging element driving portion 145, an optical system driving portion 173, etc. The imaging element driving portion 145 is adapted to read signal charges from the photoelectric conversion elements after exposure of the solid-state imaging element and transmit them.

The internal memory 185 is composed of, e.g., DRAM. In the internal memory 185, a program of various picture-taking modes programmed according to various scenes to be picture-taken, etc. are stored. The internal memory 185 is used as a work memory for the digital signal processing portion 143 and the system controlling portion 187. The internal memory 185 is used also as a buffer memory for temporarily storing picture data recorded in the recording medium 177 or buffer memory for image data to be displayed on the display portion 183.

The digital signal processing portion 143 is adapted to perform digital signal processing on digital image data from the A/D conversion portion 141 according to the operating mode directed by the operating portion 189 and is composed of, e.g., DSP. Examples of the processing performed by the digital signal processing portion 143 include black level correction (OB processing), linear matrix correction (correction on primary signals from the imaging portion for the removal of mixed components attributed to the photoelectric conversion characteristics of the imaging element, involving 3×3 matrix operation on RGB inputs), white balance adjustment (gain adjustment), gamma correction, image synthesis, synchronization, and Y/C conversion.

The recording portion 179 is adapted to perform input/output of data between recording media 177 such as memory card.

The photometric portion 181 performs photometry by extracting and integrating the brightness of picture image corresponding to predetermined range of detection and transmits the detected value thus obtained to the system controlling portion 87. The system controlling portion 187 is adapted to calculate the exposure time T (charge accumulating time), stop value, etc. on the basis of this detected value and transmits it to the driving portion 175.

The display portion 183 comprises an LCD device for example. The display portion displays an image based on image data obtained by subjecting image signal obtained by picture-taking to analog signal processing, image based on image data obtained by subjecting compressed image data recorded in the recording medium 177 to expansion, etc. The display portion 83 also can display through-image during picture-taking, various conditions of digital camera, data concerning operation, etc.

The operating portion 189 is adapted to perform various operations during the use of digital camera, e.g., operating mode of digital camera (e.g., still image picture-taking mode, animation image picture-taking mode, full-automatic picture-taking mode, high sensitivity picture-taking mode), picture-taking method, conditions, setting during picture-taking). In other words, the operating portion 189 acts also as a picture-taking predetermining unit. The operating portion 189 may have operating members corresponding to various functions provided therein but may share operating members with the display portion 183 with the interlocking with the display of the display portion 183.

Examples of the operation of the imaging device 300 having the aforementioned configuration will be described hereinafter.

The imaging device 300 according to the present embodiment can selectively perform the pixel addition or charge mixing of the aforementioned embodiments according to the predetermined picture-taking modes. The operation of the imaging device 300 will be described hereinafter taking the pixel addition described with reference to the first embodiment by way of example.

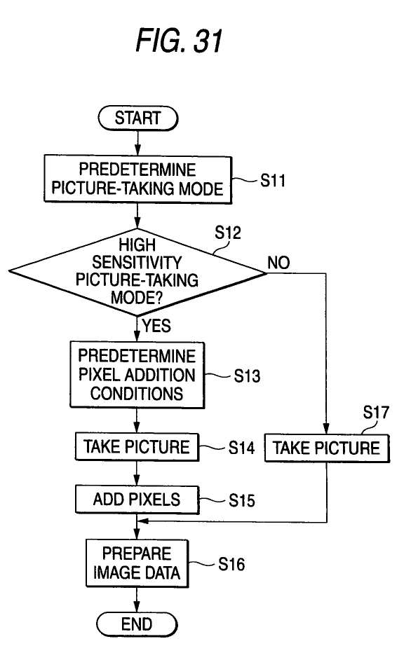

FIG. 31 is a flow chart illustrating the procedure of performing pixel addition according to the picture-taking mode.

Explaining the procedure in connection with FIG. 31, the picture-taking mode is predetermined in the system controlling portion 187 by the input from the operating portion 189 (Step 11, hereinafter referred to as “S11”). Subsequently, it is judged to see if the predetermined picture-taking mode is a high sensitivity picture-taking mode (S12). For example, in the case where a night view picture-taking mode is selected or during picture-taking with strobe, a high sensitivity picture-taking mode is selected. Further, in the full automatic picture-taking mode, in the case where the object to be picture-taken is judged to have a low brightness by the photometric portion 181, the picture-taking conditions are automatically changed to high sensitivity mode. In this case, too, it is considered that a high sensitivity picture-taking mode has been selected.

In the case where the high sensitivity picture-taking mode has been selected, pixel addition conditions are predetermined (S13). In other words, the pixel range contributing to the pixel addition is predetermined on B pixel and R pixel (or only B pixel, only R pixel). Further, the weighting coefficients k for mask pattern having the same size as the pixel range are each predetermined for weighting during pixel addition. In some detail, with respect to one pixel in G-sensitive layer, for the signals based on the various signal charges in the corresponding pixels in B-sensitive layer and R-sensitive layer at the position corresponding to the one pixel and in the surrounding pixels adjacent to the corresponding pixels, mask pattern weighting coefficient k is predetermined according to the formulae (2) and (3). The surrounding pixels adjacent to the corresponding pixel may be predetermined to be, for example, two or four pixels vertically or horizontally adjacent to the corresponding pixel or four pixels obliquely adjacent to the corresponding pixel, besides eight surrounding adjacent pixels.

Subsequently, a picture of the object is taken (S14). The analog signal outputted from the element 100 is subjected to digital conversion. B pixel and R pixel are subjected to pixel addition (S15). In this manner, an image data is formed by G pixel signal outputted without being subjected to pixel addition and B pixel signal and R pixel signal which have been subjected to pixel addition (S16).

On the other hand, in the case where the high sensitivity picture-taking mode has not been selected at S12, an ordinary picture-taking involving no pixel addition is conducted (S17). The various pixel signals obtained by picture-taking are then subjected to ordinary processing to prepare an image data (S16).

In this manner, by selectively performing pixel addition according to whether or not the picture-taking mode is a high sensitivity picture-taking mode, color resolution is considered important to avoid pixel addition when the object to be picture-taken has a high brightness and the resolution of the image is a factor governing the superiority or inferiority of image quality. In other words, an image data is prepared leaving the color resolution for R, G and B pixels unchanged. In this manner, an image data can be prepared with a high color resolution without sacrificing the resolution of the solid-state imaging element 100 itself

Further, in the case where the object to be picture-taken has a blow brightness and the rise of noise ratio causes S/N ratio to become a factor governing the superiority or inferiority of image quality, the aforementioned pixel addition is made on B pixel and R pixel to provide substantial enhancement of sensitivity resulting in the rise of S/N ratio. At the same time, on G color having a relatively high effect of visual resolution on the image quality, no pixel addition on G pixel is effected. An image data is prepared with the resolution for various G pixels left unchanged. In this manner, even when the object to be picture-taken has a low brightness, an image data having a high S/N ratio can be prepared while inhibiting the deterioration of the color resolution.

In accordance with the present imaging device, it can be selectively predetermined according to the brightness of the object to be picture-taken which should be considered important color resolution or S/N ratio. Accordingly, the imaging performance can be optimized according to the picture-taking conditions without changing the structure of the solid-state imaging element 110, making it possible to form an image data having a quality desired by the photographer.

Other examples of operation of the imaging device 300 having the aforementioned configuration will be described hereinafter.

The present imaging device 300 is adapted to selectively perform the pixel addition or charge mixing of the aforementioned various embodiments according to which the picture-taking mode is a still picture-taking mode or animation picture taking mode. The animation picture-taking mode will be described taking charge mixing allowing high speed driving by way of example.

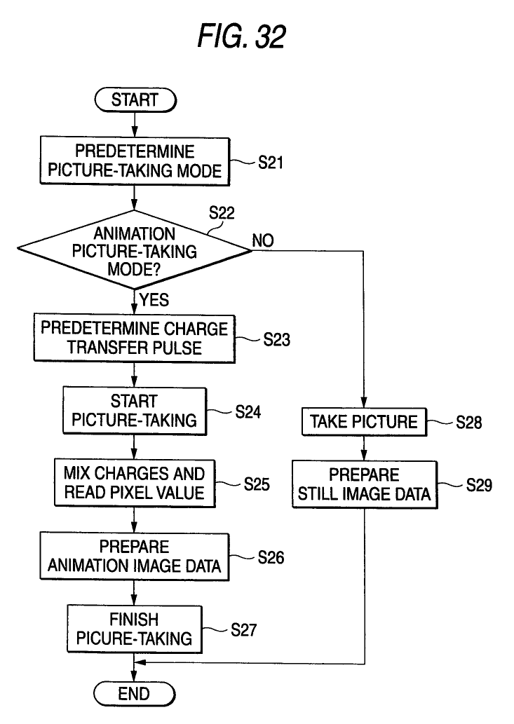

FIG. 32 is a flow chart illustrating the procedure of effecting charge mixing according to the picture-taking mode.

Explaining in connection with FIG. 32, the picture-taking mode is predetermined by the input from the operating portion 189 in the system controlling portion 187 (S21). Subsequently, it is judged to see if the predetermined picture-taking mode is an animation picture-taking mode (S22).

In the case where the animation picture-taking mode has been selected, when charge mixing is effected in the charge transmission line in the solid-state imaging element 110, the charge transfer pulse to be applied to the vertical transmission channels 31b, 31n and 31r or horizontal transmission channel 135 outputted from the imaging element driving portion 145 is predetermined as desired pattern to be subjected to charge mixing (S23). In some detail, the charge transfer pulse is prepared by adding charges accumulated in the predetermined range of pixels, respectively, on B pixel and R pixel (or only B pixel, only B pixel). The predetermined pixel range may be two or four pixels vertically or horizontally adjacent to one certain pixel or four pixels obliquely adjacent to the one pixel besides eight surrounding adjacent pixels. The weighting coefficient to be used during the pixel addition is predetermined by causing the system controlling portion 187 to act as a weighting coefficient predetermining unit according to the picture-taking conditions.

Subsequently, the solid-state imaging element 110 begins picture-taking (S24). The signal charges accumulated in B pixels and R pixels in the element 110 are transmitted while being mixed by the predetermined charge transfer pulse to read the pixel signals. In some detail, on B pixel and R pixel, charge mixing with surrounding pixels is effected. On G pixel, signal charges are read out without mixing charges (S25). These signal charges are used to prepare an animation image data (S26). This imaged data is stored in the recording portion 179. In this manner, animation picture-taking ends (S27).

On the other hand, in the case where the animation picture-taking mode has not been selected at S22, a picture of still image is taken (S28). The various pixel signals obtained by picture-taking are used to prepare a still picture image data (S29). During the still image picture-taking, pixel addition (or charge mixing) is conducted in a high sensitivity picture-taking mode according to the procedure shown in FIG. 31.

As mentioned above, in the animation picture-taking mode, as compared with the case where charge is read out of the photoelectric conversion portion of individual pixels, charges are mixed in the charge transmission line in the solid-state imaging element. Therefore, the processing time for generating pixel signals is short, allowing high speed reading. Further, by selectively performing charge mixing according to whether or not the picture-taking mode is animation picture-taking mode, signal processing can be made with the distinction between the generation of animation image data requiring a high speed pixel signal reading for the purpose of smooth picture drawing at a high resolution and other cases. Therefore, in accordance with the present imaging device, the imaging performance can be optimized according to the picture-taking mode, making it possible to exhibit performance according to the purpose of the imaging device.

In any of the aforementioned picture-taking modes, any of the two methods, i.e., pixel addition and charge mixing can be applied.

In accordance with the multi-layer solid-state imaging element described in the various embodiments, the photoelectric conversion layer has a three-layer (RGB) structure (or four-layer (RGB-GB) structure), making it possible to enjoy various advantages. For example, as image sensor comprising the related art RGB color filters, the present multi-layer solid-state imaging element can have a large area for photoelectric conversion portion. In other words, in the case where a light-receiving portion having the same size is applied, the resolution is higher by the amount of the number of colors (e.g., 3 for RGB). In this manner, an imaging element having a high resolution or an imaging element having a great percent opening can be formed. In other words, even when prepared with the same precision, an imaging element capable of taking a picture with a higher precision can be obtained. Even when no microlens is used, no shading occurs because the percent opening is so high as to give no limitation on the exit pupil distance with respect to imaging lens. Thus, problems with the related art ordinary CCD type or CMOS type image sensors can be solved.

The invention can be applied not only to laminated solid-state imaging element but also to multi-plate imaging element having various hue (R, G, B, etc.) photoelectric conversion portions disposed at different positions whereby a specific wavelength light is deflected by a prism or the like and detected. In other words, when the sensitivity characteristics of the various photoelectric conversion layers are different, charge mixing or pixel addition can be effected to substantially add a plurality of pixels, making it possible to adjust sensitivity. In this manner, even when various hue photoelectric conversion layers are made of materials having different sensitivities, an arrangement can be made such that the characteristics of the materials constituting the various photoelectric conversion portions can be economically exhibited.

The entire disclosure of each and every foreign patent application from which the benefit of foreign priority has been claimed in the present application is incorporated herein by reference, as if fully set forth.

What is claimed is:

1. An imaging device for imaging an object to generate a color image data, comprising:
a solid-state imaging element comprising:
a photoelectric conversion layer laminated above a semiconductor substrate;
a plurality of photoelectric conversion elements comprising at least two kinds of photoelectric conversion elements aligned on the semiconductor substrate for detecting colors different from that to be detected by the photoelectric conversion layer; and
a signal reading circuit formed on the semiconductor substrate for reading out color signals according to signal charge accumulated in the plurality of photoelectric conversion elements and signal charge generated in the photoelectric conversion layer; and
a color signal generating unit for generating a color signal constituting one-pixel data in the color image data on the basis of signal charge accumulated in a first photoelectric conversion element corresponding the one-pixel data among the plurality of photoelectric conversion elements and signal charge accumulated in at least one second photoelectric conversion element for detecting the same color as that of the first photoelectric conversion element, said at least one second photoelectric conversion element being adjacent to the first photoelectric conversion element.

2. The imaging device as defined in claim 1,
wherein the color signal generating unit adds a color signal corresponding to signal charge accumulated in the first photoelectric conversion element and a color signal corresponding to signal charge accumulated in said at least one second photoelectric conversion element at a predetermined ratio to generate a color signal constituting the one-pixel data.

3. The imaging device as defined in claim 1,
wherein the signal reading circuit comprises:
vertical transmission channels through which signal charge accumulated in the plurality of photoelectric conversion elements and signal charge generated in the photoelectric conversion layer are each transmitted in specific directions on the semiconductor substrate;
a horizontal transmission channel through which signal charges transmitted through the vertical transmission channels are each transmitted in the direction perpendicular to the specific directions; and
an outputting portion that outputs a color signal corresponding to signal charge transmitted through the horizontal transmission channel, and
wherein the color signal generating unit generates a color signal constituting the one-pixel data by driving the solid-state imaging element such that signal charge accumulated in the first photoelectric conversion element and signal charge accumulated in said at least one second photoelectric conversion element are mixed in the vertical transmission channels and the horizontal transmission channel.

4. The imaging device as defined in claim 1,
wherein the solid-state imaging element comprises a signal charge accumulating portion provided on the semiconductor substrate for accumulating signal charge generated in the photoelectric conversion layer, and
wherein the semiconductor substrate comprises lines having said at least two kinds of photoelectric conversion elements aligned alternately thereon and lines having the signal charge accumulating portions aligned thereon, the two lines being aligned apart from each other in the line direction at a dimension of substantially half the line alignment pitch of the photoelectric conversion elements and the signal charge accumulating portions.

5. The imaging device as defined in claim 1,
wherein the solid-state imaging element comprises a signal charge accumulating portion provided on the semiconductor substrate for accumulating signal charge generated in the photoelectric conversion layer, and
wherein the plurality of photoelectric conversion elements and the signal charge accumulating portion are aligned in the form of square lattice and each are aligned checkerwise.

6. The imaging device as defined in claim 1,
wherein the signal reading circuit comprises: an MOS transistor; and a signal line connected to the MOS transistor, and
wherein the plurality of photoelectric conversion elements comprise the at least two kinds of photoelectric conversion elements laminated in the depth direction of the semiconductor substrate which are aligned on the same plane in the semiconductor substrate.

7. The imaging device as defined in claims 1,
wherein the solid-state imaging element comprises a plurality of microlens, provided above the photoelectric conversion layer, for converging light rays onto the plurality of photoelectric conversion elements.

8. The imaging device as defined in claim 1,
wherein the solid-state imaging element comprises a plurality of microlens, provided interposed between the photoelectric conversion layer and the plurality of photoelectric conversion elements, for converging light rays onto the plurality of photoelectric conversion elements.

9. The imaging device as defined in claim 1,
wherein the photoelectric conversion layer detects green light and said at least two kinds of photoelectric conversion elements comprise photoelectric conversion elements for detecting red light and photoelectric conversion elements for detecting blue light.

10. The imaging device as defined in claim 1,
wherein the photoelectric conversion layer comprises an organic material.

11. A digital camera which performs imaging by using an imaging device as defined in claim 1.

12. A color image data generating method for imaging an object to generate a color image data, on a solid-state imaging element which comprises: a photoelectric conversion layer laminated above a semiconductor substrate; a plurality of photoelectric conversion elements comprising at least two kinds pf photoelectric conversion elements aligned on the semiconductor substrate for detecting colors different from that to be detected by the photoelectric conversion layer; and a signal reading circuit formed on the semiconductor substrate for reading out color signals according to signal charge accumulated in the plurality of photoelectric conversion elements and signal charge generated in the photoelectric conversion layer, the method comprising:
a color signal generating step of generating a color signal constituting one-pixel data in the color image data on the basis of signal charge accumulated in a first photoelectric conversion element corresponding the one-pixel data among the plurality of photoelectric conversion elements and signal charge accumulated in at least one second photoelectric conversion element for detecting the same color as that of the first photoelectric conversion element, said at least one second photoelectric conversion element being adjacent to the first photoelectric conversion element.

13. The color image data generating method as defined in claim 12,
wherein the color signal generating step adds a color signal corresponding to signal charge accumulated in the first photoelectric conversion element and a color signal corresponding to signal charge accumulated in said at least one second photoelectric conversion element at a predetermined ratio to generate a color signal constituting the one-pixel data.

14. The color image data generating method as defined in claim 12,
wherein the signal reading circuit comprises:
vertical transmission channels through which signal charge accumulated in the plurality of photoelectric conversion elements and signal charge generated in the photoelectric conversion layer are each transmitted in specific directions on the semiconductor substrate;
a horizontal transmission channel through which signal charges transmitted through the vertical transmission channels are each transmitted in the direction perpendicular to the specific directions; and
an outputting portion that outputs a color signal corresponding to signal charge transmitted through the horizontal transmission channel, and
wherein the color signal generating step generates a color signal constituting the one-pixel data by driving the solid-state imaging element such that signal charge accumulated in the first photoelectric conversion element and signal charge accumulated in said at least one second photoelectric conversion element are mixed in the vertical transmission channels and the horizontal transmission channel.

15. A color image data generating method for generating a color image data from at least three color signals obtained by imaging an object, wherein said at least three color signals comprise: a first color signal in a number corresponding to total pixel data in the color image data; a second color signal in a number corresponding to a part of the total pixel data in the color image data; and a third color signal in a number corresponding to the other part of the total pixel data in the color image data, the method comprising:
a color signal providing step of obtaining the first color signal, the second color signal and the third color signal;
a fourth color signal generating step of subtracting the first color signal from the second color signal on the same sample points as that of the color signals thus obtained;
a fifth color signal generating step of subtracting the first color signal from the third color signal on the same sample points as that of the color signals thus obtained; and
a color signal generating step of generating a color signal constituting one-pixel data in the color image data on the basis of the fourth and fifth color signals.

16. The color image data generating method as defined in claim 15,
wherein the color signal generating step comprises:
a first interpolating step of interpolating, in points having the fifth color signals present thereon but free of the fourth color signals, the fourth color signals present in the surroundings of the points;
a second interpolating step of interpolating, in points having the fourth color signals present thereon but free of the fifth color signals, the fifth color signals present in the surroundings of the points;
a sixth color signal generating step of adding: the fourth color signals interpolated in sample points which have originally had no fourth color signals present thereon; and the fourth color signals present in the surroundings of the sample points at a predetermined ratio to generate a sixth color signal on the sample points,
a seventh color signal generating step of adding: the fifth color signals interpolated in the sample points which have originally had no fifth color signals present thereon; and the fifth color signals present in the surroundings of the sample points at a predetermined ratio to generate a seventh color signal on the sample points; and
an adding step of adding the sixth color signal or the seventh color signal and the first color signal present on the same sample points as the color signal, to generate a color signal constituting the one-pixel data.

17. The color image data generating method as defined in claim 15,
wherein the color signal generating step comprises:
a first interpolating step of interpolating, in points having the fifth color signals present thereon but free of the fourth color signals, the fourth color signals present in the surroundings of the points;
a second interpolating step of interpolating, in points having the fourth color signals present thereon but free of the fifth color signals, the fifth color signals present in the surroundings of the points;
a sixth color signal generating step of adding: the fourth color signals present on various sample points; and the fourth color signals present in the surroundings of the sample points at a predetermined ratio to generate a sixth color signal on the sample points;
a seventh color signal generating step of adding the fifth color signals present on various sample points and the fifth color signals present in the surroundings of the sample points at a predetermined ratio to generate a seventh color signal on the sample points; and
an adding step of adding the sixth color signal present and the first color signal present on the same sample points as the color signal and adding the seventh color signal and the first color signal present on the same sample points as the color signal, to generate a color signal constituting the one-pixel data.

18. The color image data generating method as defined in claim 15, further comprising:
a step of adding the second color signal and the color signal of the same kind present on the sample points in the surroundings of the sample point having the second color signal present thereon at a predetermined ratio to generate new second color signals on the sample points; and
a step of adding the third color signal and the color signal of the same kind present on the sample points in the surroundings of the sample point having the third color signal present thereon at a predetermined ratio to generate new third color signals on the sample points,
wherein the fourth color signal generating step uses the new second color signal instead of the second color signal to generate the fourth color signal, and
wherein the fifth color signal generating step uses the new third color signal instead of the third color signal to generate the fifth color signal.

19. The color image data generating method as defined in claim 15,
wherein the first to third color signals are obtained from a solid-state imaging element,
wherein the solid-state imaging element comprising:
one photoelectric conversion layer laminated above a semiconductor substrate;
a signal charge accumulating portion formed on the surface of the semiconductor substrate for accumulating a signal charge generated in the photoelectric conversion layer; and
two kinds of photoelectric conversion elements formed on the surface of the semiconductor substrate for detecting different colors, respectively,
wherein the signal charge accumulating portion is formed in a number corresponding to total pixel data in the color image data,
the two kinds of photoelectric conversion elements are, in sum total, formed in a number corresponding to the total pixel data in the color image data,
the first color signal is a signal corresponding to the signal charge accumulated in the signal charge accumulating portion,
the second color signal is a signal corresponding to the signal charge generated in one of the two photoelectric conversion elements, and
the third color signal is a signal corresponding to the signal charge generated in the other of the two photoelectric conversion elements.

20. An imaging device having a solid-state imaging element which comprises a plurality of photoelectric conversion layers each having a plurality of pixels and reads a signal charge out of the pixels in the photoelectric conversion layers as a pixel signal, comprising:
a first photoelectric conversion layer for absorbing light rays in a green wavelength range to generate a signal charge;
at least one second photoelectric conversion layer for absorbing mainly light rays in a wavelength range different from the green wavelength range to generate a signal charge; and
a pixel signal generating unit for generating a pixel signal according to the signal charge from the first photoelectric conversion layer and the second photoelectric conversion layer,
wherein the pixel signal generating unit generates, on one pixel in the first photoelectric conversion layer, a pixel signal for the position of the one pixel on the basis of: a value according to processing of various signal charges in the corresponding pixel in the second photoelectric conversion layer at the position corresponding to the one pixel and in surrounding pixels adjacent to the corresponding pixel and; a value according to signal charge in the one pixel in the first photoelectric conversion layer.

21. The imaging device as defined in claim 20,
wherein the first light-receiving layer and said at least one second light-receiving layer are laminated on each other and the first light-receiving layer is disposed on a light incidence side to transmit light rays in wavelength ranges other than the green wavelength range.

22. An imaging device having a multi-layer solid-state imaging element which comprises a plurality of photoelectric conversion layers each having a plurality of pixels and reads a signal charge out of the pixels in the photoelectric conversion layers, comprising:
a G photoelectric conversion layer disposed in the uppermost layer on a light incidence side which absorbs G (green) light to generate a G signal charge according to an amount of the G light and transmits R (red) light and B (blue) light;
a B photoelectric conversion layer which absorbs B light to generate a B signal charge according to an amount of the B light and transmits R light;
an R photoelectric conversion layer which absorbs R light to generate an R signal charge according to an amount of the R light; and
a signal processing portion which reads a signal charge out of pixels in the G photoelectric conversion layer, the B photoelectric conversion layer and the R photoelectric conversion layer to generate a pixel signal,
wherein the signal processing portion generates, on one pixel in the G photoelectric conversion layer, a pixel signal for the position of the one pixel on the basis of: a value according to processing of various signal charges in the corresponding pixel in a photoelectric conversion layer other than the G photoelectric conversion layer at the position corresponding to the one pixel and in the surrounding pixels adjacent to the corresponding pixel and; a value according to signal charge in the one pixel in the G photoelectric conversion layer.

23. The imaging device as defined in claim 22, wherein the photoelectric conversion layer other than the G photoelectric conversion layer comprise a B photoelectric conversion layer.

24. The imaging device as defined in claim 22, wherein the photoelectric conversion layer other than the G photoelectric conversion layer comprises an R photoelectric conversion layer.

25. The imaging device as defined in claim 20,
wherein the processing of signal charge comprises mixing charges accumulated in the various pixels in the photoelectric conversion layers.

26. The imaging device as defined in claim 22,
wherein the processing of signal charge comprises mixing charges accumulated in the various pixels in the photoelectric conversion layers.

27. The imaging device as defined in claim 20,
wherein the processing of signal charge comprises addition of pixel signals generated on the basis of signal charges in the various pixels in the photoelectric conversion layers.

28. The imaging device as defined in claim 22,
wherein the processing of signal charge comprises addition of pixel signals generated on the basis of signal charges in the various pixels in the photoelectric conversion layers.

29. The imaging device as defined in claim 27, further comprising an analog circuit for adding the pixel signals by analog signal processing.

30. The imaging device as defined in claim 28, further comprising an analog circuit for adding the pixel signals by analog signal processing.

31. The imaging device as defined in claim 27, further comprising a low pass filter for passing the pixel signals.

32. The imaging device as defined in claim 28, further comprising a low pass filter for passing the pixel signals.

33. The imaging device as defined in claim 27, further comprising a digital circuit for adding the pixel signals by digital signal processing.

34. The imaging device as defined in claim 28, further comprising a digital circuit for adding the pixel signals by digital signal processing.

35. The imaging device as defined in claim 25, further comprising a weighting unit for effecting weighting according to the relative pixel position corresponding to the pixel to be processed in the signal charge processing.

36. The imaging device as defined in claim 26, further comprising a weighting unit for effecting weighting according to the relative pixel position corresponding to the pixel to be processed in the signal charge processing.

37. The imaging device as defined in claim 35, further comprising:
a photometric unit for detecting the brightness of an object; and
a weighting coefficient predetermining unit for predetermining a weighting coefficient according to results of brightness detected by the photometric unit.

38. The imaging device as defined in claim 36, further comprising:
a photometric unit for detecting the brightness of an object; and
a weighting coefficient predetermining unit for predetermining a weighting coefficient according to results of brightness detected by the photometric unit.

39. The imaging device as defined in claim 35, further comprising:
a picture-taking mode predetermining unit for predetermining either high sensitivity mode or ordinary mode; and
a weighting coefficient predetermining unit for predetermining a weighting coefficient according to the picture-taking mode predetermined by the picture-taking mode predetermining unit.

40. The imaging device as defined in claim 36, further comprising:
a picture-taking mode predetermining unit for predetermining either high sensitivity mode or ordinary mode; and
a weighting coefficient predetermining unit for predetermining a weighting coefficient according to the picture-taking mode predetermined by the picture-taking mode predetermining unit.

41. The imaging device as defined in claim 35, further comprising:
a picture-taking mode predetermining unit for predetermining either still mode or animation mode; and
a weighting coefficient predetermining unit for predetermining a weighting coefficient according to the picture-taking mode predetermined by the picture-taking mode predetermining unit.

42. The imaging device as defined in claim 36, further comprising:
a picture-taking mode predetermining unit for predetermining either still mode or animation mode; and
a weighting coefficient predetermining unit for predetermining a weighting coefficient according to the picture-taking mode predetermined by the picture-taking mode predetermining unit.

43. A digital camera which performs imaging by using an imaging device as defined in claim 20.

44. A digital camera which performs imaging by using an imaging device as defined in claim 22.

45. A solid-state imaging element signal processing method for generating a multi-color image signal using a solid-state imaging element, wherein the solid-state imaging element which comprises a plurality of photoelectric conversion layers each having a plurality of pixels and reads a signal charge out of the pixels in the photoelectric conversion layers as a pixel signal, the solid-state imaging element comprising: a first photoelectric conversion layer for absorbing light rays in a green wavelength range to generate a signal charge; and at least one second photoelectric conversion layer for absorbing mainly light rays in a wavelength range different from the green wavelength range to generate a signal charge, the method comprising:
reading out each of: a signal charge in one pixel in the first photoelectric conversion layer; and various signal charges in the corresponding pixel in the second electrode layer at the position corresponding to the one pixel and the surrounding pixels adjacent to the corresponding pixel; and
generating a multi-color pixel signal according to the one pixel on all the pixel positions on the basis of: a value according to signal charge in the one pixel in the first photoelectric conversion layer; and a value according to the various signal charges in the corresponding pixel in the second photoelectric conversion layer and the surrounding pixels.

46. A signal processing method on a multi-layer solid-state imaging element which comprises a laminate of photoelectric conversion layers each having a plurality of pixels and reads a signal charge out of the various pixels in the photoelectric conversion layers to generate a multi-color pixel signal,
wherein the solid-state imaging element comprises: a G photoelectric conversion layer which absorbs G (green) light to generate a G signal charge according to an amount of the G light, the G photoelectric conversion layer being disposed in the uppermost layer on light incidence side; a B photoelectric conversion layer which absorbs B (blue) light to generate a B signal charge according to an amount of the B light; and an R photoelectric conversion layer which absorbs R (blue) light to generate an R signal charge according to an amount of the R light, the method comprising:
reading out each of: a signal charge in one pixel in the G photoelectric conversion layer; and various signal charges in the corresponding pixel in a photoelectric conversion layer other than the G photoelectric conversion layer at the position corresponding to the one pixel and the surrounding pixels adjacent to the corresponding pixel; and
generating a multi-color pixel signal according to the one pixel on all the pixel positions on the basis of: a value according to signal charge in the one pixel in the G photoelectric conversion layer and; a value according to various signal charges in the corresponding pixel in the photoelectric conversion layer other than the G photoelectric conversion layer and the surrounding pixels.

47. The signal processing method on solid-state imaging element as defined in claim 46,
wherein the signal charge processing comprises final addition of various signal charges in a corresponding pixel B (m, n) corresponding to a position of a pixel G (m, n) (in which m and n each are an integer) two-dimensionally aligned in the G photoelectric conversion layers and surrounding pixels B (m+a, n+b) (in which a and b each are a positive or negative integer) with respect to the pixel G (m, n).

48. The signal processing method on solid-state imaging element as defined in claim 46, comprising
a signal charge processing which comprises final addition of various signal charges in a corresponding pixel R (m, n) corresponding to a position of a pixel G (m, n) (in which m and n each are an integer) two-dimensionally aligned in the G photoelectric conversion layers and surrounding pixels R (m+a, n+b) (in which a and b each are a positive or negative integer) with respect to the pixel G (m, n).

49. The signal processing method on solid-state imaging element as defined in claim 46, comprising
an addition of signal charges which comprises mixing of charges accumulated in the various pixels in the photoelectric conversion layers.

50. The signal processing method on solid-state imaging element as defined in claim 46, comprising
an addition of signal charges which comprises addition of pixel signals generated on the basis of signal charges in the various pixels in the photoelectric conversion layers.

51. The signal processing method on solid-state imaging element as defined in claim 46, comprising
an signal charge processing which comprises multiplication of each of the corresponding pixels and the surrounding pixels by a weighting coefficient according to the pixel position.

52. The signal processing method on solid-state imaging element as defined in claim 51,
wherein the weighting coefficient is predetermined according to a purpose of picture-taking.

53. The signal processing method on solid-state imaging element as defined in claim 51,
wherein the weighting coefficient is predetermined great for the corresponding pixel but small for the surrounding pixels.

54. The signal processing method on solid-state imaging element as defined in claim 51,
wherein the higher the brightness of an object to be picture-taken is, the more is predetermined the weighting coefficient for the corresponding pixel greater than that for the surrounding pixels, and
the lower the brightness of the object to be picture-taken is, the smaller is predetermined the difference between the weighting coefficient for the corresponding pixel and the weighting coefficient for the surrounding pixels.

55. The signal processing method on solid-state imaging element as defined in claim 51,
wherein the weighting coefficient for the corresponding pixel is predetermined greater than that for the surrounding pixels in the case of still picture-taking while the difference between the weighting coefficient for the corresponding pixel and the weighting coefficient for the surrounding pixels is predetermined small in the case of animated picture-taking.

56. A digital camera controlling method comprising performing imaging by using a signal processing method on solid-state imaging element as defined in claim 45.

57. A digital camera controlling method comprising performing imaging by using a signal processing method on solid-state imaging element as defined in claim 55.
